(19) United States
(12) Patent Application Publication
(10) Pub. No.: US 2019/0377520 A1
(43) Pub. Date: Dec. 12, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/421,571

(22) Filed: May 24, 2019

(30) Foreign Application Priority Data
Jun. 7, 2018 (JP) 2018-109870

(51) Int. Cl. G06F 3/12

(52) U.S. Cl. CPC G06F 3/1205; G06F 3/1236; G06F 3/1259; G06F 3/1204

(57) ABSTRACT

An information processing apparatus comprising includes a control unit. In a case where plural configurations are present as collaboration candidates and plural combinations of configurations that are required for executing a collaborative function are present, the control unit controls providing a notification of at least one combination among the plural combinations.

### CROSS-REFERENCE TO RELATED APPLICATIONS

This application is based on and claims priority under 35 USC 119 from Japanese Patent Application No. 2018-109870 filed Jun. 7, 2018.

### BACKGROUND

### (i) Technical Field

The present disclosure relates to an information processing apparatus and a non-transitory computer readable medium.

### (ii) Related Art

Japanese Unexamined Patent Application Publication No. 2015-177504 discloses an apparatus that acquires information on a cost that is required when a collaborative operation is executed by using a plurality of apparatuses and that presents to a user, the information on the cost in association with the apparatuses that execute the collaborative operation.

Japanese Unexamined Patent Application Publication No. 2015-223006 discloses a system that limits a user's usage amount when devices work in collaboration with each other.

### SUMMARY

Aspects of non-limiting embodiments of the present disclosure relate to providing a notification of a combination of configurations that are required for executing a collaborative function.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a control unit. In a case where a plurality of configurations are present as collaboration candidates and a plurality of combinations of configurations that are required for executing a collaborative function are present, the control unit controls providing a notification of at least one combination among the plurality of combinations.

### BRIEF DESCRIPTION OF THE DRAWINGS

An exemplary embodiment of the present disclosure will be described in detail based on the following figures, wherein:

FIG. 1 is a block diagram illustrating a configuration of an information processing system according to the exemplary embodiment;

FIG. 2 is a block diagram illustrating a configuration of a terminal apparatus;

FIG. 3 is a block diagram illustrating a configuration of a device;

FIG. 4 illustrates a collaborative function management table;

FIG. 5 illustrates a screen;

FIG. 6 illustrates a screen;

FIG. 7 illustrates a screen;

FIG. 8 illustrates a screen;

FIG. 9 illustrates a screen;

FIG. 10 illustrates a screen;

FIG. 11 illustrates a screen;

FIG. 12 illustrates a screen;

FIG. 13 illustrates a screen;

FIG. 14 illustrates a screen;

FIG. 15 illustrates a screen; and

FIG. 16 illustrates a screen.

### DETAILED DESCRIPTION

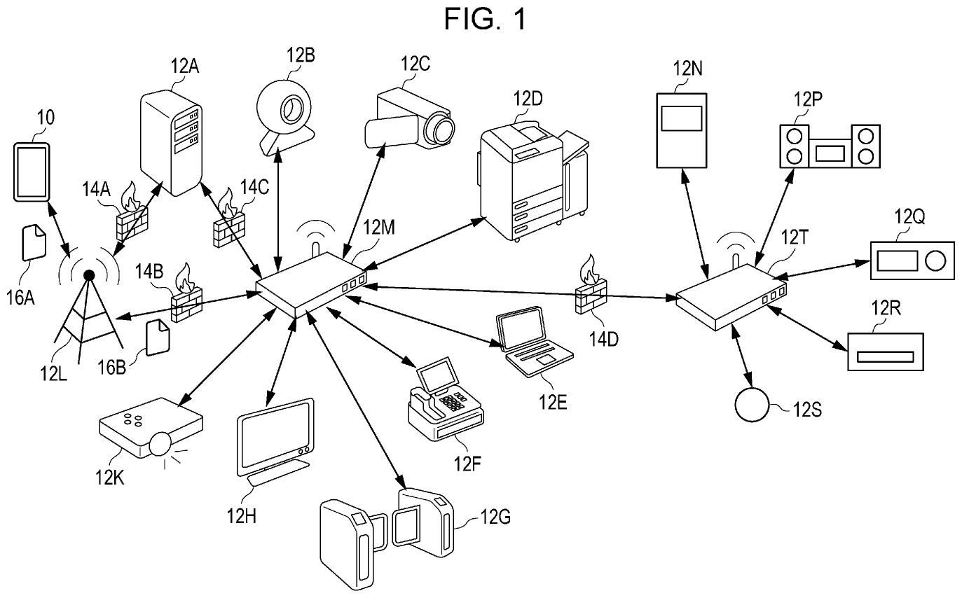

An information processing system according to an exemplary embodiment of the present disclosure will be described with reference to FIG. 1. FIG. 1 illustrates an example of the information processing system according to the exemplary embodiment.

The information processing system according to the exemplary embodiment includes one or more terminal apparatuses and one or more devices. In the example illustrated in FIG. 1, the information processing system includes a terminal apparatus 10 and devices 12A, 12B, 12C, 12D, 12E, 12F, 12G, 12H, 12K, 12L, 12M, 12N, 12P, 12Q, 12R, 12S, and 12T. These configurations are merely examples, and the information processing system may include a plurality of terminal apparatuses 10 and other devices. In the following description, the devices will be referred to as “device 12” or “devices 12” when they do not have to be distinguished from one another. Note that the concept of the device 12 may encompass the terminal apparatus 10. That is, the terminal apparatus 10 may be treated as one of the devices 12.

The terminal apparatus 10 and each of the devices 12 have a function of communicating with another apparatus. The communication may be wireless or wired communication. For example, the terminal apparatus 10 and each of the devices 12 may communicate with another apparatus via a communication path such as the Internet or another network, may communicate directly with another apparatus, may communicate with another apparatus via a relay device that functions as a hub, or may communicate with another apparatus via a so-called cloud or a server. Each of the devices 12 may be a so-called Internet of Things (IoT) device. In addition, a firewall may be provided in the communication path. The firewall prevents unauthorized access into the communication path. In the example illustrated in FIG. 1, firewalls 14A to 14D are provided.

The terminal apparatus 10 is an apparatus such as a personal computer (PC), a tablet PC, a smartphone, or a mobile phone and has a function of communicating with another apparatus. The terminal apparatus 10 may be a wearable terminal (e.g., wristwatch-type terminal, wristband-type terminal, glasses-type terminal, ring-type terminal, contact-lens-type terminal, in-body-embedded type terminal, or in-ear wearable terminal). In addition, the terminal apparatus 10 may include a flexible display as a display apparatus. Examples of the flexible display include an organic electroluminescent display (flexible organic EL display), a display in the form of electronic paper, a flexible liquid crystal display, and the like. Any flexible display using another display method may be used. In the flexible display, a display part may be flexibly deformed and may be, for example, bent, folded, wound, twisted, or stretched. The entire terminal apparatus 10 may be formed as the flexible display, or the flexible display and other components may be functionally or physically independent of each other.

Each of the devices 12 is an apparatus having functions and is, for example, an image forming apparatus having an image forming function (e.g., a scan function, a print function, a copy function, or a facsimile function), a PC, a tablet PC, a smart phone, a mobile phone, a robot (a humanoid robot, an animal-shaped robot other than the humanoid robot, or any other type of robot), a projector, a display apparatus such as a liquid crystal display, a recording apparatus, a reproducing apparatus, an image capturing apparatus such as a camera, a refrigerator, a rice cooker, a microwave oven, a coffee maker, a vacuum cleaner, a washing machine, an air conditioner, a lighting apparatus, a timepiece, a security surveillance camera, a motor vehicle, a two-wheeled vehicle, an aircraft (e.g., unmanned aerial vehicle (so-called drone), a game console, any of various sensing devices (e.g., a temperature sensor, a humidity sensor, a voltage sensor, or an electric current sensor), or the like. Each of the devices 12 may provide information to a user (the device 12 may be an image forming apparatus, a PC, or the like, for example) or does not have to provide information to a user (the device 12 may be a sensing device, for example). In addition, all of the plurality of devices 12 that are used for executing a collaborative function, which will be described later, may provide information to a user; some of the devices 12 may provide information to a user while the other devices 12 do not provide information to a user; or none of the devices 12 may provide information to a user. The concept of the device 12 may encompass every type of device. For example, the concept of the device 12 may encompass an information device, a movie device, an audio device, and other devices.

The device 12 may be used for executing an independent function or the collaborative function by working with another device 12 in collaboration with each other. The independent function is, for example, executable by using one of the devices 12. The collaborative function is, for example, executable by using a plurality of devices 12. For the independent function and the collaborative function, for example, hardware or software included in one or more of the devices 12 is used. In a case where a device 12 does not work in collaboration with another device 12, the device 12 may be independently used for executing the independent function upon reception of an instruction from a user. It is needless to say that a device 12 (e.g., a sensing device) that is used for executing a function without receiving an instruction from a user may also be included in the information processing system.

Now, the collaborative function will be described. The entire device 12, a specific part of the device 12, a specific function of software, a set of functions including a plurality of functions, or the like may be used for the collaborative function. For example, if a function is assigned to each part of the device 12, the collaborative function may be a function that uses the part. A specific example will be described below by referring to a multi-function peripheral having a plurality of functions for image forming. A print function is assigned to a main part of the multi-function peripheral, a scan function is assigned to a scan unit (e.g., a part corresponding to a scanner lid, a scanner glass, or an automatic document feeder) of the multi-function peripheral, and a post-processing function (e.g., a stapling function) is assigned to a post-processing apparatus of the multi-function peripheral. In this case, the main part, the scan unit, or the post-processing apparatus of the multi-function peripheral may be used for the collaborative function. In addition, as software, a set of functions in units of blocks, such as robotics process automation (RPA), may be used for the collaborative function. In addition, if software has a plurality of functions, the collaborative function may be a function that uses some of the plurality of functions. The set of functions includes a plurality of functions, and a process using the set of functions is executed by simultaneously or sequentially executing the plurality of functions. Furthermore, the collaborative function may use only hardware, only software, or both hardware and software. Furthermore, data such as an image file or a document file may be used for the collaborative function.

The collaborative function may be a function that becomes executable by collaboration of a plurality of devices 12 of different types or may be a function that becomes executable by collaboration of a plurality of devices 12 of the same type. The collaborative function may alternatively be a function that has been unusable before collaboration. For example, by collaboration of a device 12 (printer) having a print function and a device 12 (scanner) having a scan function, a copy function becomes executable as the collaborative function. That is, the copy function becomes executable by collaboration of the print function and the scan function.

The concept of the collaborative function may encompass a composite function that enables execution of a new function by causing the plurality of devices 12 to work in collaboration with each other. For example, by combining a plurality of displays, an expansion display function as the composite function may be realized. As another example, by combining a television set and a recorder, a recording function as the composite function may be realized. The recording function is, for example, a function of recording an image displayed on the television set. In addition, by combining a plurality of cameras, an imaging field expanding function as the composite function may be realized. This expanding function is an imaging function by connecting, for example, imaging fields of cameras to each other. In addition, by combining a telephone and a translation machine or translation software, a translated-conversation function (function of translating conversations on the telephone) as the composite function may be realized. In the above manner, the concept of the collaborative function may encompass a function that becomes executable by causing the plurality of devices 12 or a plurality of pieces of software of the same type to work in collaboration with each other, and a function that becomes executable by causing the plurality of devices 12 or a plurality of pieces of software of different types to work in collaboration with each other.

In addition, a connected home (a system in which IoT technology is used to interconnect the devices 12 that are home appliances or the like over a network) may be made by using the plurality of devices 12, and the collaborative function may be used in the connected home. In this case, the devices 12 may be connected to each other via a specific server, or the devices 12 may be connected to each other without a specific server.

Furthermore, the plurality of devices 12 may work in collaboration with each other by using If This Then That (IFTTT) to execute the collaborative function. That is, the collaborative function may be execution of an action (process) of another device 12 if an event as a trigger occurs in a certain device 12. For example, triggered by detection of opening of a door by a sensor that is one of the devices 12, a collaborative function for executing an action of turning on a lighting apparatus that is another one of the devices 12 may be executed. Also, triggered by an action of another certain device 12, a still another device 12 may execute an action. This function may also be encompassed in the concept of the collaborative function. Furthermore, a function of causing a plurality of web services to work in collaboration and Application Programming Interface (API) collaboration for causing a plurality of systems, services, and the like to work in collaboration by utilizing an API may also be encompassed in the concept of the collaborative function.

In the example illustrated in FIG. 1, the device 12A is a server, the device 12B is a security surveillance camera, the device 12C is a video camera, the device 12D is a multi-function peripheral having an image forming function, the device 12E is a laptop PC, the device 12F is a cash register, the device 12G is an entrance/exit gate, the device 12H is a TV monitor, the device 12K is a projector, the device 12L is a communication base station, and the device 12M is a relay device (e.g., a router). The devices 12A and 12M and the terminal apparatus 10 are connected to the device 12L. The devices 12A to 12K are connected to the device 12M. The firewall 14A is provided in a communication path between the device 12A and the device 12L. The firewall 14B is provided in a communication path between the device 12L and the device 12M. The firewall 14C is provided in a communication path between the device 12A and the device 12M.

The device 12N is an air cleaner, the device 12P is an audio device, the device 12Q is a recorder, the device 12R is an air conditioner, the device 12S is a sensor, and the device 12T is a relay device (e.g., a router). The devices 12N to 12S are connected to the device 12T. The device 12T is connected to the device 12M. The firewall 14D is provided in a communication path between the device 12T and the device 12M.

For example, data 16A and data 16B (e.g., instruction information, file, and the like) are transmitted and received between the terminal apparatus 10 and the devices 12.

The relay device may control the other devices 12 (e.g., hardware of the other devices 12 and software installed in the other devices 12) that are connected to the relay device, for example. In addition, the relay device may acquire various pieces of information by using the Internet or the like. The relay device may serve as a server or may manage data and user information, for example. The relay device may be a so-called smart speaker (a device having a communication function and a speaker function) or may be a device that has a communication function but does not have a speaker function. The relay device may be installed indoors (e.g., on the floor, the ceiling, or a table in a room) or outdoors. In addition, the relay device may be a movable device (e.g., a self-running device).

Each of the devices 12 is configured to execute an independent function. The independent function is executed in accordance with an instruction from a user or is automatically executed regardless of an instruction from a user. In addition, the devices 12 may be used for executing the collaborative function that is set for the devices 12. For example, setting information indicating details of the collaborative function is stored in the devices 12 to be used for the collaborative function, and the devices 12 work in collaboration with each other to execute the collaborative function indicated by the setting information stored in the devices 12.

As described above, there are one or more terminal apparatuses 10 and one or more devices 12 in a real space. In addition, one or more pieces of software are installed in each of the one or more terminal apparatuses 10 and each of the one or more devices 12. The information processing system according to the exemplary embodiment may obviously include a terminal apparatus 10 or a device 12 in which software is not installed. The software is present in a virtual space (e.g., a virtual space formed in a storage region in which the software is stored).

In the exemplary embodiment, if a plurality of configurations are present as collaboration candidates and a plurality of combinations of configurations that are required for executing a collaborative function are present, a notification of at least one combination among the plurality of combinations is provided. Each configuration is a device 12, software, or a target. The target is data such as a file to which a collaborative function is to be applied, a physical object, or the like. The providing of a notification is display of information by using a display unit, audio output, or the like.

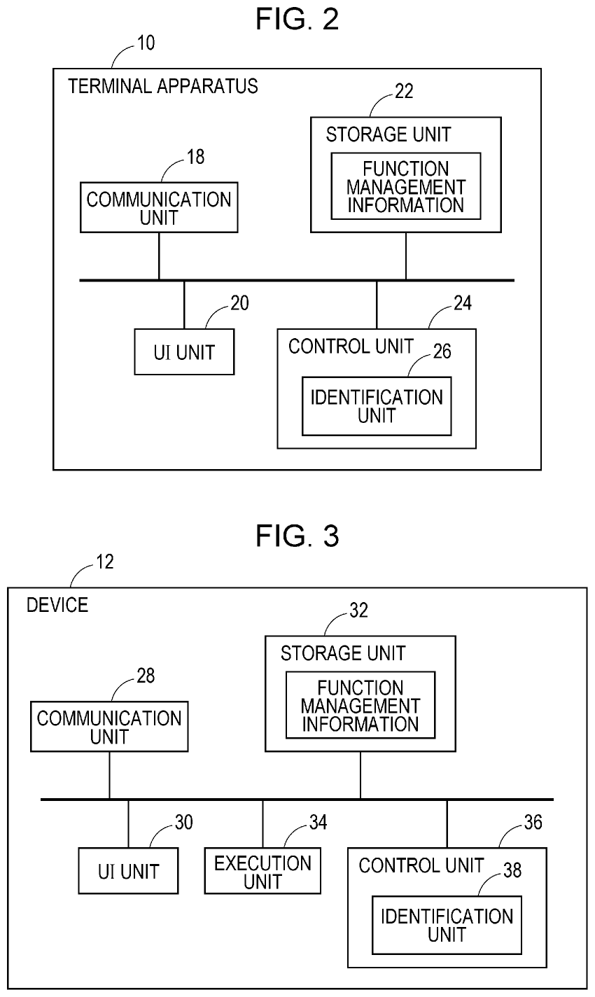

Now, a configuration of the terminal apparatus 10 will be described in detail with reference to FIG. 2. FIG. 2 illustrates the configuration of the terminal apparatus 10.

A communication unit 18 is a communication interface and has a function of transmitting data to other apparatuses and a function of receiving data from other apparatuses. The communication unit 18 may be a communication interface having a wireless communication function or may be a communication interface having a wired communication function. The communication unit 18 is compliant with, for example, one or more types of communication schemes, and may communicate with a communication partner in accordance with a communication scheme that is suitable for the communication partner (i.e., a communication scheme supported by the communication partner). Examples of the communication scheme include infrared communication, visible light communication, Wi-Fi (registered trademark) communication, short-range wireless communication (e.g., near field communication (NFC)), and the like. For short-range wireless communication, Felica (registered trademark), Bluetooth (registered trademark), a radio frequency identifier (RFID), or the like is used. In addition, the communication unit 18 may be compliant with a fifth-generation mobile communication system (5G). It is needless to say that wireless communication of another scheme may also be used for short-range wireless communication. The communication unit 18 may switch the communication scheme or a frequency band in accordance with the communication partner or may switch the communication scheme or a frequency band in accordance with the ambient environment. Examples of the frequency band include 2.4 GHz and 5 GHz.

A user interface (UI) unit 20 is a user interface and includes a display unit and an operation unit. The display unit is a display apparatus such as a liquid crystal display. The display unit may be a flexible display. The operation unit is an input apparatus such as a touch panel or a keyboard. The UI unit 20 may be a user interface that serves as the display unit and the operation unit (e.g., a touch display or an apparatus that displays an electronic keyboard or the like on a display). In addition, the UI unit 20 may further include a sound collecting unit such as a microphone and an audio generating unit such as a speaker. In this case, information may be input to the terminal apparatus 10 by audio, and information may be output by audio.

A storage unit 22 is a storage apparatus such as a hard disk or a memory (e.g., a solid state drive (SSD)). The storage unit 22 stores, for example, various data items, various programs (pieces of software), and the like. Examples of the programs include an operating system (OS) and various application programs (pieces of software). The storage unit 22 further stores device address information indicating the addresses of the devices 12 (e.g., Internet Protocol (IP) addresses or Media Access Control (MAC) addresses allocated to the devices 12) and the like. In addition, the storage unit 22 stores function management information.

Now, the function management information will be described. The function management information is information for managing collaborative functions that are executable by using the configurations (e.g., hardware, software, or targets). The function management information is, for example, created in advance and stored in the storage unit 22. A collaborative function is executable by using a plurality of configurations. The terminal apparatus 10 may also be used for a collaborative function. Software and a file to be used for a collaborative function may be stored in the storage unit 22 of the terminal apparatus 10 or may be stored in a device 12.

The function management information is, for example, information indicating the correspondence between a combination of a plurality of configurations used for a collaborative function (a combination of pieces of configuration identification information for identifying the configurations) and function information indicating details of the collaborative function.

If a configuration is a device, the configuration identification information is information for identifying the device (device identification information). If a configuration is software, the configuration identification information is information for identifying the software (software identification information). If a configuration is a target, the configuration identification information is information for identifying the target (target identification information). The configuration identification information for identifying the device may include information indicating a function of the device. Similarly, the configuration identification information for identifying the software may include information indicating a function of the software.

Examples of the device identification information include a name of the device 12, a device ID, information indicating a type of the device 12, a model number of the device 12, information for managing the device 12 (e.g., property management information), information indicating a location where the device 12 is installed (device location information), an image associated with the device 12 (device image), device address information, and the like. The device image is, for example, an external appearance image of the device 12. The external appearance image may be an image representing an exterior of the device 12 (e.g., a housing of the device), an image representing a state in which the housing is open and an interior may be seen from outside (e.g., an internal structure), or an image representing a state in which the device is covered with a wrapping sheet or the like. The device image may be an image generated by imaging the device 12 by using an imaging apparatus such as a camera (e.g., an image representing the exterior or interior of the device), or may be an image schematically representing the device 12 (e.g., an icon). The device image may be a still image or a moving image. The data of the device image may be stored in the storage unit 22 or may be stored in another apparatus such as a device 12.

Examples of the software identification information include a name of the software, a software ID, information indicating a type of the software, a model number of the software, information for managing the software, an image associated with the software (software image), and the like. The software image is, for example, an image representing the software (e.g., an icon). The software image may be a still image or a moving image. The data of the software image may be stored in the storage unit 22 or may be stored in another apparatus such as a device 12.

Examples of the target identification information include a name of the target, a target ID, information indicating a type of the target, an image associated with the target (target image), and the like. In a case where the target is a file (data), a name of the file (e.g., an image file or a document file) or the like is used as the target identification information. In a case where the target is a physical object (e.g., a product), a name of the object or the like is used as the target identification information. The target image may be an image (e.g., a still image or a moving image) generated by imaging a physical object by using an imaging apparatus such as a camera, or an image that schematically represents the target (e.g., an icon). The data of the target image may be stored in the storage unit 22 or may be stored in another apparatus such as a device 12.

Note that the function management information may be stored in another apparatus such as a device 12. In this case, the function management information does not have to be stored in the terminal apparatus 10.

A control unit 24 is configured to control operations of units of the terminal apparatus 10. For example, the control unit 24 executes a variety of programs (pieces of software), controls communication by using the communication unit 18, controls providing a notification of information (e.g., display of information or audio output) by using the UI unit 20, writes information to the storage unit 22, reads information from the storage unit 22, and receives information that has been input to the terminal apparatus 10 by using the UI unit 20. In addition, the control unit 24 includes an identification unit 26.

The identification unit 26 is configured to identify, if a plurality of combinations of configurations that are required for executing a collaborative function are present, at least one combination among the plurality of combinations by referring to the function management information. The control unit 24 controls providing a notification of the at least one combination of configurations identified by the identification unit 26. For example, the control unit 24 may cause the display unit of the UI unit 20 to display information indicating the at least one combination or may output audio information indicating the at least one combination from a speaker.

Now, a configuration of each device 12 will be described in detail with reference to FIG. 3. FIG. 3 illustrates an example of the configuration of the device 12. Note that FIG. 3 illustrates a common configuration of the devices 12, not a configuration that is unique to each of the devices 12.

A communication unit 28 is a communication interface and has a function of transmitting data to other apparatuses and a function of receiving data from other apparatuses. The communication unit 28 may be a communication interface having a wireless communication function or may be a communication interface having a wired communication function. The communication unit 28 is compliant with, for example, one or more types of communication schemes, and may communicate with a communication partner in accordance with a communication scheme that is suitable for the communication partner. The communication scheme may be any of the above-described communication schemes. The communication unit 28 may switch the communication scheme or a frequency band in accordance with the communication partner or may switch the communication scheme or a frequency band in accordance with the ambient environment.

A UI unit 30 is a user interface and includes a display unit and an operation unit. The display unit is a display apparatus such as a liquid crystal display. The display unit may be a flexible display. The operation unit is an input apparatus such as a touch panel or a keyboard. The UI unit 30 may be a user interface that serves as the display unit and the operation unit. In addition, the UI unit 30 may further include a sound collecting unit such as a microphone and an audio generating unit such as a speaker. In this case, information may be input to the device 12 by audio, and information may be output by audio. Note that a device 12 that does not include the UI unit 30 may be included in the information processing system. For example, a sensing device that does not provide information to a user does not have to include the UI unit 30.

A storage unit 32 is a storage apparatus such as a hard disk or a memory (e.g., an SSD). The storage unit 32 stores, for example, various data items, various programs (pieces of software), and the like. Examples of the programs include an OS and various application programs (pieces of software). Note that the OS and the application programs are not stored in the storage unit 32 depending on the device 12. The storage unit 32 may further store device address information of other devices 12 and terminal address information indicating an address of the terminal apparatus 10 (e.g., an IP address or a MAC address allocated to the terminal apparatus 10). In addition, the storage unit 32 stores function management information. The function management information is, for example, like the function management information stored in the terminal apparatus 10, information indicating the correspondence between a plurality of configurations and collaborative functions that are executable by using the plurality of configurations.

An execution unit 34 is configured to execute a function. For example, in a case where a device 12 is an image forming apparatus, the execution unit 34 executes an image forming function such as a scan function, a print function, or a copy function.

A control unit 36 is configured to control operations of units of the device 12. For example, the control unit 36 executes various programs (pieces of software), controls communication by using the communication unit 28, controls providing a notification of information (e.g., display of information or audio output) by using the UI unit 30, receives information that has been input to the device 12 by using the UI unit 30, writes information to the storage unit 32, reads information from the storage unit 32, and controls the execution unit 34. In addition, the control unit 36 includes an identification unit 38.

Similarly to the identification unit 26 included in the terminal apparatus 10, the identification unit 38 is configured to identify a combination of configurations that are required for executing a collaborative function by referring to the function management information. The control unit 36 controls providing a notification of the combination of configurations identified by the identification unit 38. For example, the control unit 36 may cause the display unit of the UI unit 30 to display information indicating the combination or may output audio information indicating the combination from a speaker.

In a case where the combination of configurations is identified by the identification unit 26 of the terminal apparatus 10, the identification unit 38 does not have to be provided in the device 12. Likewise, in a case where the combination of configurations is identified by the identification unit 38 of the device 12, the identification unit 26 does not have to be provided in the terminal apparatus 10. In addition, in a case where the combination of configurations is not identified by the device 12, the function management information does not have to be stored in the device 12. Although a case where the identification unit 26 of the terminal apparatus 10 performs an identification process will be described below, the identification unit 38 of the device 12 may obviously perform the identification process.

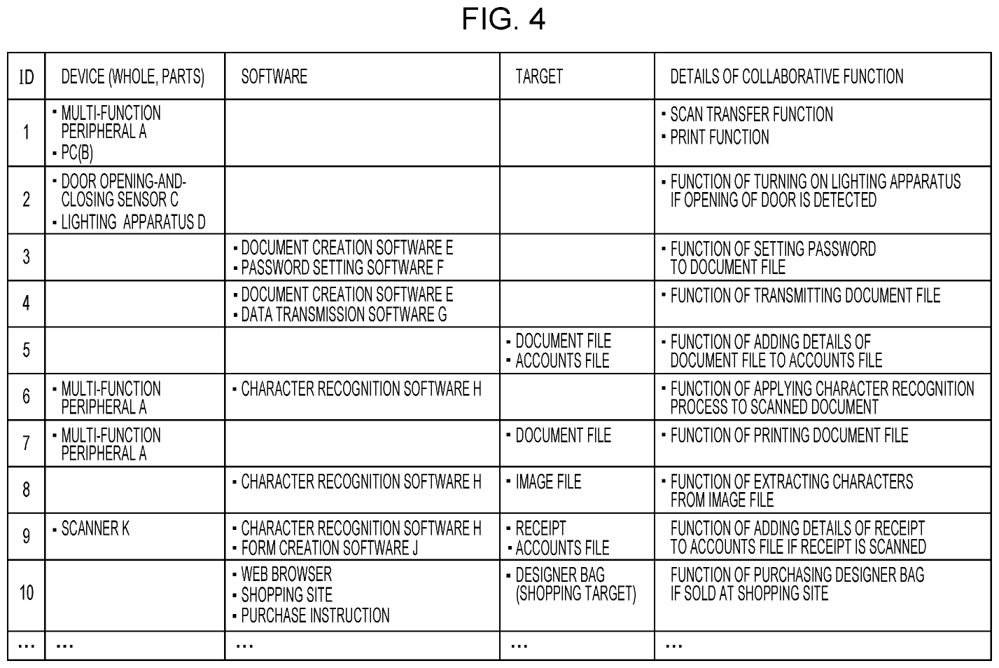

The function management information will be described below in detail with reference to FIG. 4. FIG. 4 illustrates an example of a collaborative function management table as the function management information.

In the collaborative function management table illustrated in FIG. 4, as an example, an ID, information indicating a combination of configurations (the devices 12, software, targets), and information indicating details of a collaborative function correspond to one another. The devices 12 registered in the collaborative function management table are the devices 12 included in the information processing system. In a case where a new device 12 is added to the information processing system, a collaborative function that is executable by using the device 12 may be registered in the collaborative function management table. Each collaborative function will be described below.

A collaborative function with an ID “1” is “SCAN TRANSFER FUNCTION” and “PRINT FUNCTION”. This collaborative function is executable by using a multi-function peripheral A and a PC (B) as examples of the devices 12. The scan transfer function as the collaborative function is a function of transferring image data to the PC (B), the image data being generated through scanning by using the multi-function peripheral A. The print function as the collaborative function is a function of transmitting data (e.g., a document file or an image file) stored in the PC (B) to the multi-function peripheral A and printing the data by using the multi-function peripheral A.

A collaborative function with an ID “2” is “FUNCTION OF TURNING ON LIGHTING APPARATUS IF OPENING OF DOOR IS DETECTED”. This collaborative function is executable by using a door opening-and-closing sensor C and a lighting apparatus D as examples of the devices 12. The door opening-and-closing sensor C is a sensor that detects opening and closing of a door. This collaborative function is a function of turning on the lighting apparatus D if the door opening-and-closing sensor C detects opening of the door. More specifically, if the door opening-and-closing sensor C detects opening of the door, information indicating the detection result is transmitted from the door opening-and-closing sensor C to the lighting apparatus D, so as to turn on the lighting apparatus D. Note that the information indicating the detection result may be transmitted from the door opening-and-closing sensor C to a relay device, and upon reception of the information indicating the detection result, the relay device may turn on the lighting apparatus D.

A collaborative function with an ID “3” is “FUNCTION OF SETTING PASSWORD TO DOCUMENT FILE”. This collaborative function is executable by using document creation software E and password setting software F. This collaborative function is, for example, a function of setting a password by using the password setting software F for a document file that is being edited or displayed by using the document creation software E. Note that the software may be stored in the terminal apparatus 10 or may be stored in the devices 12.

A collaborative function with an ID “4” is “FUNCTION OF TRANSMITTING DOCUMENT FILE”. This collaborative function is executable by using the document creation software E and data transmission software G. This collaborative function is a function of transmitting, to an address by using the data transmission software G, a document file that is being edited or displayed by using the document creation software E.

A collaborative function with an ID “5” is “FUNCTION OF ADDING DETAILS OF DOCUMENT FILE TO ACCOUNTS FILE”. This collaborative function is a function to be applied to a document file and an accounts file as targets. In a case where document creation software corresponds with the document file and accounts software corresponds with the accounts file, the collaborative function is executable by using a function of the document creation software and a function of the accounts software.

These collaborative functions are executable by using the configurations of the same type, but may also be executable by using the configurations of different types. Now, this will be described in more detail.

A collaborative function with an ID “6” is executable by using a device 12 and software. This collaborative function is “FUNCTION OF APPLYING CHARACTER RECOGNITION PROCESS TO SCANNED DOCUMENT”. This collaborative function is executable by using the multi-function peripheral A (an example of the device 12) and character recognition software H (an example of the software). This collaborative function is a function of scanning a document by using the multi-function peripheral A and applying, to an image generated through the scanning, a character recognition process by using the character recognition software H.

A collaborative function with an ID “7” is executable by using a device 12 and a file. This collaborative function is “FUNCTION OF PRINTING DOCUMENT FILE”. This collaborative function is executable by using the multi-function peripheral A and a document file. This collaborative function is a function of transmitting a document file stored in a storage location to the multi-function peripheral A and printing the document file by using the multi-function peripheral A.

A collaborative function with an ID “8” is executable by using software and a file. This collaborative function is “FUNCTION OF EXTRACTING CHARACTERS FROM IMAGE FILE”. This collaborative function is executable by using the character recognition software H and an image file. This collaborative function is a function of applying a character recognition process to the image file by using the character recognition software H.

Although each of these collaborative functions is executable by using two configurations, the collaborative function may be executable by using three or more configurations. This will be described below in more detail.

A collaborative function with an ID “9” is executable by using a scanner K as a device 12, the character recognition software H and a form creation software J each as software, and a receipt and an accounts file each as a file. This collaborative function is “FUNCTION OF ADDING DETAILS OF RECEIPT TO ACCOUNTS FILE IF RECEIPT IS SCANNED”. More specifically, this collaborative function is a function of scanning the receipt by using the scanner and applying a character recognition process to an image generated through the scanning by using the character recognition software so as to extract a character string from the image and adding the character string to the accounts file by using the form creation software.

A collaborative function registered in the collaborative function management table as a collaborative function with an ID “10” is a collaborative function that is executable by using a web browser, a specific shopping site, and information indicating a purchase instruction each as a piece of software, and a specific designer bag (shopping target) as a target. This collaborative function is “FUNCTION OF PURCHASING DESIGNER BAG IF SOLD AT SHOPPING SITE”. More specifically, this collaborative function is a function of monitoring a specific shopping site by using the web browser and performing a purchase process of a specific designer bag if the designer bag is sold at the shopping site.

The collaborative functions illustrated in FIG. 4 are merely examples, and a collaborative function other than the above collaborative functions may be registered in the collaborative function management table.

A device 12 that executes a function may be controlled by a relay device to which the device 12 is connected or may be controlled by the terminal apparatus 10. In a case where the device 12 is controlled by the relay device, the relay device controls the device 12 by transmitting a control signal for controlling the device 12 to the device 12. In a case where the device 12 is controlled by the terminal apparatus 10, the terminal apparatus 10 controls the device 12 by transmitting the control signal to the device 12 directly or via a relay device.

Each of the configurations registered in the collaborative function management table may be identified on the basis of subordinate concept information (e.g., a unique name of the configuration (for example, a specific product name, a model number, a web site name, a uniform resource locator (URL), or the like)) or may be identified on the basis of superordinate concept information (e.g., a generic name or a generic term of the configuration).

Now, a process performed by the information processing system according to the exemplary embodiment will be described in detail.

In the following examples, a user operates the terminal apparatus 10 so as to specify configurations to be used for a collaborative function and set the collaborative function, for example. It is needles to say that the user may operate a device 12 so as to specify the configurations and set the collaborative function, for example.

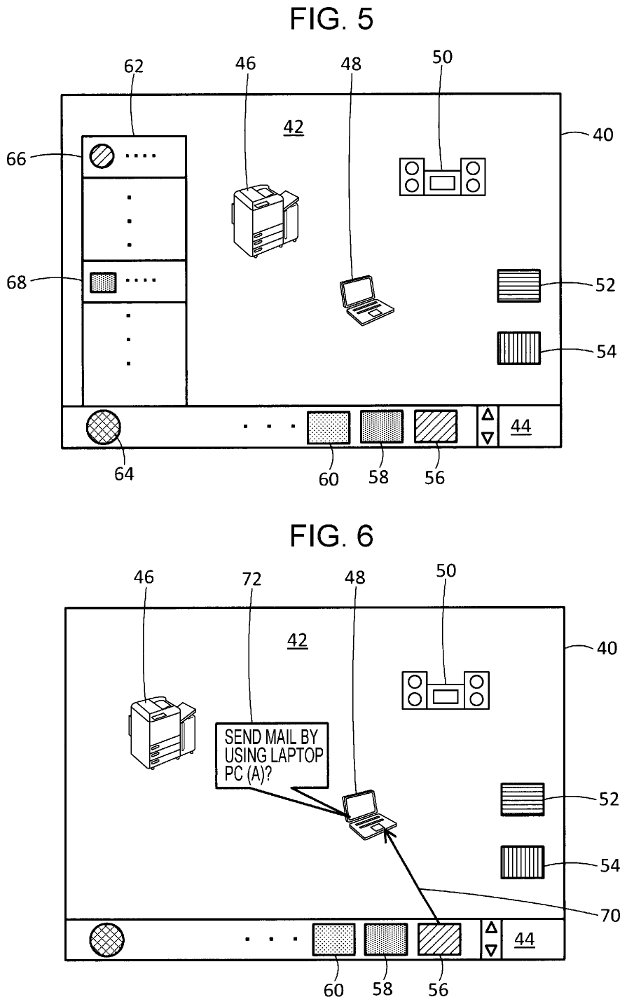

A screen displayed on the UI unit 20 of the terminal apparatus 10 will be described with reference to FIG. 5. FIG. 5 illustrates an example of the screen. The control unit 24 of the terminal apparatus 10 causes the UI unit 20 to display a screen 40 and causes various pieces of information to be displayed on the screen 40. The screen 40 is, for example, a home screen, a desktop screen, or the like. The screen 40 includes a main display region 42 and a taskbar 44. In the main display region 42, images such as icons, various windows, and the like are displayed. For example, in the main display region 42, an image 46 associated with a multi-function peripheral, an image 48 associated with a laptop PC, an image 50 associated with an audio device, an image 52 associated with document software, an image 54 associated with image management software, and the like are displayed. In the taskbar 44, images such as icons are displayed. For example, in the taskbar 44, an image 56 associated with email software, an image 58 associated with presentation software, an image 60 associated with document creation software, and the like are displayed. In addition, in the taskbar 44, a button image 64 for displaying a menu 62 is displayed. If the user presses the button image 64 (for example, if the user clicks the button image 64), the menu 62 is displayed in the main display region 42. On the menu 62, a software list is displayed. For example, on the menu 62, images 66 and 68 associated with software are displayed. Note that if the user presses an arrow button image displayed in the taskbar 44, an image associated with other software may be displayed in the taskbar 44.

For example, the control unit 24 of the terminal apparatus 10 may cause any of the following to be displayed on the screen 40: an image associated with a device 12 identified by the terminal apparatus 10 or another apparatus; an image associated with software that is installed in the terminal apparatus 10; and an image associated with software that is installed in the device 12. For example, an image of the device 12 is captured by an image capturing apparatus such as a camera, and on the basis of image data generated by capturing the image, the device 12 is identified. This identification process may be performed by the terminal apparatus 10 or another apparatus (e.g., a server). The control unit 24 may cause an image associated with the device 12, which is identified in this manner, to be displayed on the screen 40. In addition, the control unit 24 may cause any of the following to be displayed on the screen 40: an image associated with a device 12 that is connected to the terminal apparatus 10; and an image associated with software that is installed in the device 12. For example, the terminal apparatus 10 searches for the device 12 that is connected to the terminal apparatus 10, and the control unit 24 causes an image associated with the found device 12 to be displayed on the screen 40. In addition, the control unit 24 may cause an image associated with software to be displayed on the screen 40, the software being installed in the found device 12. Furthermore, the control unit 24 may cause an image associated with data to be displayed on the screen 40, the data being stored in the terminal apparatus 10 or in the device 12.

Now, examples of the information processing system according to the exemplary embodiment will be described in detail.

### FIRST EXAMPLE

Now, a first example will be described with reference to FIG. 6. FIG. 6 illustrates the screen 40. For example, if a user specifies the image 56 associated with email software by operating the UI unit 20, by referring to the collaborative function management table, the identification unit 26 identifies configurations (the devices 12, software, targets) that are usable for executing a collaborative function in collaboration with the email software. In an exemplary case, the email software is installed in a laptop PC (A) associated with the image 48, and a function (collaborative function) of sending email by using the laptop PC (A) and the email software is registered in the collaborative function management table. In this case, the identification unit 26 identifies the laptop PC (A) as a collaboration candidate. Note that information indicating software that is installed in each of the devices 12 is registered in advance in the collaborative function management table.

In a case where the laptop PC (A) is identified as the collaboration candidate in the above manner, the control unit 24 controls providing a guide to the laptop PC (A). For example, the control unit 24 causes an image 70 to be displayed on the screen 40. The image 70 represents an arrow extending from the image 56 specified by the user to the image 48 associated with the laptop PC (A). That is, the control unit 24 causes the image 70 of the arrow to be displayed on the screen 40, the arrow connecting the image 56 and the image 48 to each other. In addition, the control unit 24 causes a display frame 72 to be displayed on the screen 40 in association with the image 48, and also causes information to be displayed within the display frame 72, the information indicating details of the collaborative function that is executable by using the laptop PC (A) and the email software.

For example, if the user specifies the display frame 72 by operating the UI unit 20 (e.g., if the user clicks the display frame 72), the control unit 24 sets the collaborative function for the laptop PC (A). For example, the control unit 24 transmits control information indicating the collaborative function to the laptop PC (A). On the basis of the control information, the laptop PC (A) starts the email software installed in the laptop PC (A). Thus, the user can create email by using the laptop PC (A).

In a case where the email software is not installed in the laptop PC (A), the control unit 24 does not cause the guide to the laptop PC (A) to be displayed. Even in a case where the email software is not installed in the laptop PC (A), as long as it is possible to install the email software in the laptop PC (A), the control unit 24 may cause information thereof to be displayed on the screen 40.

In addition, although the image 46 associated with the multi-function peripheral and the image 50 associated with the audio device are displayed on the screen 40, the multi-function peripheral and the audio device are not registered in the collaborative function management table as the devices 12 that are usable for executing a collaborative function in collaboration with the email software specified by the user. Thus, the control unit 24 does not cause a guide to the multi-function peripheral and a guide to the audio device to be displayed.

In the above example, the email software and the laptop PC (A) correspond to a combination of configurations that are required for executing a collaborative function, and the combination is displayed by using the image 70 of the arrow. Note that the control unit 24 may output information (e.g., a name) for identifying the laptop PC (A) as audio information from a speaker in place of, or in addition to, display of the image 70 of the arrow. Besides the display of the arrow image, the control unit 24 may enlarge an image that is a guide target (e.g., the image 48) displayed on the screen 40.

A notification of the combination of configurations that are required for executing a collaborative function is provided in the above manner, and thus, the user can recognize the configurations with ease.

### SECOND EXAMPLE

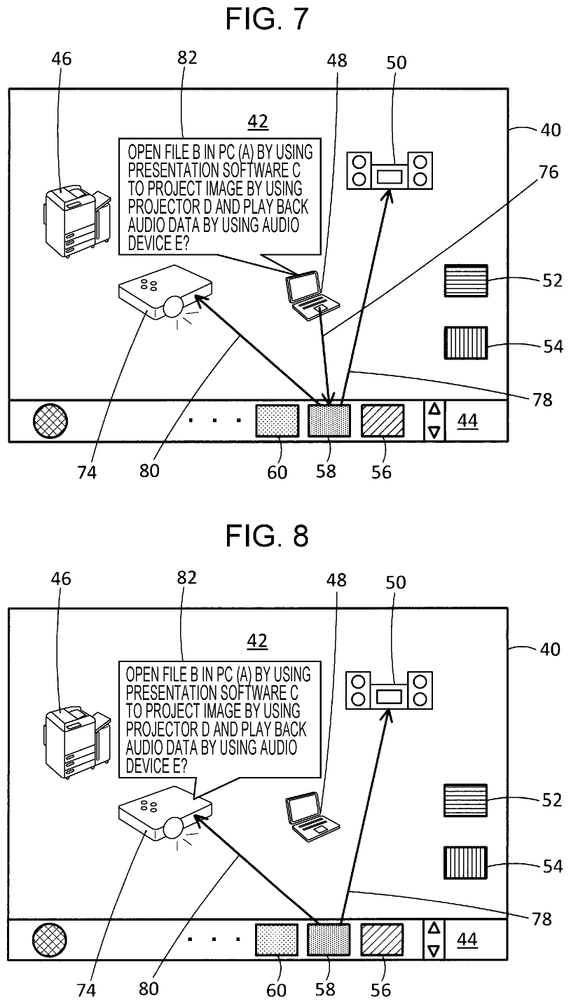

Now, a second example will be described with reference to FIG. 7. FIG. 7 illustrates the screen 40. In the second example, the control unit 24 provides guides to configurations in accordance with the order of use in a collaborative function. The control unit 24 may provide guides to configurations in accordance with the order of processes in the collaborative function or may provide guides to configurations in accordance with the order of use of data. For example, a device that stores data to be used for the collaborative function corresponds to a higher-order configuration, and a device 12 or software that uses the data corresponds to a lower-order configuration. It is needless to say that this is merely an example, and the order may be determined by other criteria.

For example, if a user specifies the image 48 associated with the laptop PC (A) by operating the UI unit 20, by referring to the collaborative function management table, the identification unit 26 identifies configurations (the devices 12, software, targets) that are usable for executing a collaborative function in collaboration with the laptop PC (A). In an exemplary case, a collaborative function that is executable by using the laptop PC (A), presentation software C, an audio device E, and a projector D is registered in the collaborative function management table. In this case, the identification unit 26 identifies the presentation software C, the audio device E, and the projector D as collaboration candidates.

In a case where the presentation software C, the audio device E, and the projector D are identified as the collaboration candidates in the above manner, the control unit 24 causes information to be displayed on the screen 40, the information providing guides to these configurations. In this exemplary case, the collaborative function is a function of opening a file B stored in the laptop PC (A) by using the presentation software C, projecting an image by using the projector D, and playing back audio information by using the audio device E. Note that the presentation software C is installed in the laptop PC (A). In this collaborative function, the presentation software C installed in the laptop PC (A) is executed, and subsequently, the functions of the projector D and the audio device E are executed. That is, the laptop PC (A) and the presentation software C each correspond to a first-level configuration, and the projector D and the audio device E each correspond to a second-level configuration. In this case, the control unit 24 provides guides to the configurations in accordance with the level (order of execution). Specifically, the control unit 24 causes images 76, 78, and 80 to be displayed on the screen 40. The image 76 represents an arrow connecting the image 48, which is associated with the laptop PC (A), and the image 58, which is associated with the presentation software C, to each other (the image 76 represents an arrow extending from the image 48 to the image 58). The image 78 represents an arrow connecting the image 58, which is associated with the presentation software C, and the image 50, which is associated with the audio device E, to each other (the image 78 represents an arrow extending from the image 58 to the image 50). The image 80 represents an arrow connecting the image 58, which is associated with the presentation software C, and an image 74, which is associated with the projector D, to each other (the image 80 represents an arrow extending from the image 58 to the image 74). Display of such arrow images represents execution of the presentation software C installed in the laptop PC (A), followed by execution of processes of the audio device E and the projector D. This makes it possible to provide the order of processes to the user with high visibility.

In addition, the control unit 24 causes a display frame 82 to be displayed on the screen 40 in association with the image 48, and also causes information to be displayed within the display frame 82, the information indicating details of the above collaborative function. For example, if the user specifies the display frame 82 by operating the UI unit 20 (e.g., if the user clicks the display frame 82), the control unit 24 sets the collaborative function for the laptop PC (A), the presentation software C, the projector D, and the audio device E. For example, the control unit 24 transmits control information indicating the collaborative function to the laptop PC (A), the projector D, and the audio device E. On the basis of the control information, each of the laptop PC (A), the projector D, and the audio device E executes an assigned process.

As another example, in a case where the presentation software C is installed in the terminal apparatus 10, the presentation software C installed in the terminal apparatus 10 may be used for the above collaborative function. In this exemplary case, the file B stored in the laptop PC (A) is transmitted from the laptop PC (A) to the terminal apparatus 10, the file B is opened in the terminal apparatus 10 by using the presentation software C, and further, the file B is transmitted from the terminal apparatus 10 to the projector D and the audio device E. Then, an image included in the file B is projected by using the projector D, and audio information included in the file B is played back by using the audio device E. Also in this case, since the file B is transmitted in the order of the laptop PC (A), the terminal apparatus 10, the projector D, and the audio device E, the arrow images represent the order of processes on the file B or the order of use of the file B. In this case, the laptop PC (A) corresponds to the first-level configuration, the presentation software C installed in the terminal apparatus 10 corresponds to the second-level configuration, and the projector D and the audio device E each correspond to a third-level configuration.

Alternatively, the identification unit 26 may identify a collaboration candidate on the basis of a use history of the configurations, compatibility between the configurations, or the user's use trend.

For example, the use history of the configurations is managed, and information indicating the use history is stored in the terminal apparatus 10, the devices 12, or an external apparatus such as a server. In addition, for each configuration, a history of collaboration with another configuration is managed as a use history, and information indicating the use history is stored in the terminal apparatus 10, the devices 12, or an external apparatus such as a server. By referring to the information indicating the use history, the identification unit 26 of the terminal apparatus 10 may identify, as a collaboration candidate, another configuration that has worked in collaboration with the configuration specified by the user, another configuration whose collaboration frequency (e.g., the total number of times of collaboration or the number of times of collaboration per unit period) is higher than or equal to a threshold, or another configuration whose level determined by the collaboration frequency is high. The higher the frequency is, the higher the level is.

A specific example will be described. In a case where a user specifies the laptop PC (A), if the frequency of collaboration of the laptop PC (A) and the presentation software C is higher than or equal to the threshold, the identification unit 26 identifies the presentation software C as a collaboration candidate. As another example, if the collaboration frequency is the highest or a level determined by the collaboration frequency is higher than or equal to a predetermined level, the identification unit 26 identifies the presentation software C as a collaboration candidate. The same applies to the projector D and the audio device E. This makes it possible to present to the user, a configuration having a high possibility to be used in collaboration with the laptop PC (A) specified by the user.

Even in a case where a collaborative function that is executable by causing the laptop PC (A) and the multi-function peripheral associated with the image 46 to work in collaboration with each other is registered in the collaboration function management table, for example, if the laptop PC (A) and the multi-function peripheral have never worked in collaboration with each other or the collaboration frequency is lower than the threshold, the identification unit 26 does not identify the multi-function peripheral as a collaboration candidate. As a result, an arrow image pointing at the image 46 is not displayed. This makes it possible to prevent a configuration having a low possibility to be used in collaboration with the laptop PC (A) from being presented to the user.

That is, combinations of configurations that are usable for executing a collaborative function include a combination of the laptop PC (A) and the multi-function peripheral, a combination of the laptop PC (A) and the presentation software C, a combination of the laptop PC (A) and the projector D, a combination of the laptop PC (A) and the audio device E, and a combination of the laptop PC (A) and a plurality of configurations. From among the plurality of combinations, at least one combination is presented to the user. For example, as in the above case, a combination is identified on the basis of the use history, and the identified combination is presented to the user.

The above use history may be managed for each user or each user account, and information indicating the use history of each user or each user account may be stored in the terminal apparatus 10, the devices 12, or an external apparatus such as a server. The use history corresponds to the user's or the user account's use trend. For example, by referring to the information indicating the use history of a user who has logged in to the terminal apparatus 10 or a user account, the identification unit 26 may identify, as a collaboration candidate, another configuration that has worked in collaboration with the configuration specified by the user or may identify the collaboration candidate on the basis of the collaboration frequency. Thus, the collaboration candidate in accordance with the user's use trend is presented to the user.

The identification unit 26 may also identify the collaboration candidate on the basis of the compatibility between the configurations. The compatibility is determined in advance on the basis of, for example, the number of collaborative functions that are executable by using the configurations, and information indicating the compatibility is registered in advance in the collaborative function management table. For example, in a case where the number of collaborative functions that are executable by using the laptop PC (A) and the presentation software C is greater than or equal to a threshold, the identification unit 26 identifies the presentation software C as the collaboration candidate. On the other hand, in a case where the number of collaborative functions that are executable by using the laptop PC (A) and the multi-function peripheral is less than the threshold, the identification unit 26 does not identify the multi-function peripheral as the collaboration candidate. A guide (arrow image) to the presentation software C is displayed on the screen 40 whereas a guide to the multi-function peripheral is not displayed on the screen 40. This makes it possible to present to the user, a collaboration candidate with which the number of collaborative functions is greater than or equal to the threshold.

From among the configurations (the device 12, software, targets) displayed on the screen 40, the identification unit 26 may identify, as the collaboration candidate, another configuration having a higher level that is determined by the number of executable collaborative functions. The larger the number is, the higher the order is. For example, in a case where the number of collaborative functions that are executable by using the laptop PC (A) and the presentation software C is the largest or the level determined by the number is higher than or equal to a predetermined level, the identification unit 26 identifies the presentation software C as the collaboration candidate. The same applies to the projector D and the audio device E. Even in a case where collaborative functions that are executable by causing the laptop PC (A) and the multi-function peripheral to work in collaboration with each other are registered in the collaborative function management table, if the level determined by the number of collaborative functions is lower than the predetermined level, the identification unit 26 does not identify the multi-function peripheral as the collaboration candidate.

Note that the compatibility between the configurations may be determined by a factor other than the number of collaborative functions. For example, the compatibility between the configurations may be determined by performance of the devices 12, performance of the software, a standard of the devices 12, a standard of the software, a manufacturer, a version, and so on.

If a configuration included in a combination of configurations is specified by the user, the control unit 24 does not have to display a guide to the specified configuration. This process will be described with reference to FIG. 8. FIG. 8 illustrates the screen 40. For example, if a user specifies the image 58 associated with the presentation software C as a second-level configuration, the control unit 24 hides from display, the image 76 of the arrow connecting the image 48, which is associated with the laptop PC (A), and the image 58 to each other. Thus, the user can recognize that the image 58 is specified by the user. Also in this case, the control unit 24 causes a guide from the second-level configuration to a third-level configuration to be displayed on the screen 40. In the example illustrated in FIG. 8, the control unit 24 causes the image 78 of the arrow to be displayed on the screen 40, the arrow connecting the image 58, which is associated with the presentation software C, and the image 50, which is associated with the audio device E, to each other. The same applies to the image 80 that provides a guide to the projector D.

### THIRD EXAMPLE

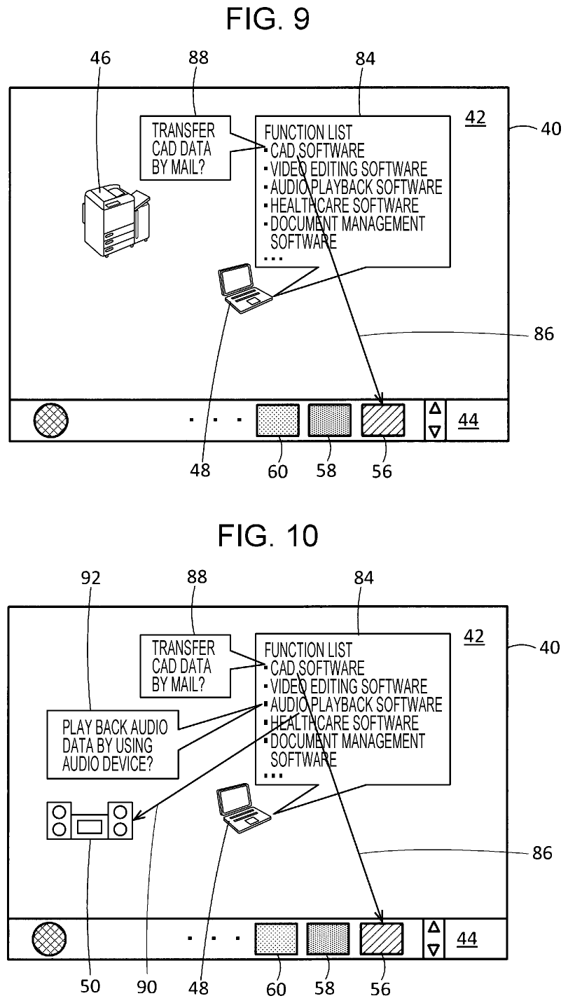

Now, a third example will be described with reference to FIG. 9. FIG. 9 illustrates the screen 40. In the third example, if a user specifies a configuration, the control unit 24 causes a list of functions of the specified configuration to be displayed on the screen 40, and provides a notification of a combination of configurations in units of functions included in the list. A specific example will be described below.

As illustrated in FIG. 9, if the user specifies the image 48 associated with the laptop PC (A) by operating the UI unit 20, the control unit 24 causes a list 84 of functions of the laptop PC (A) to be displayed on the screen 40. Note that the functions of the devices 12 and the pieces of software are registered in the collaborative function management table in advance, for example, and by referring to the collaborative function management table, the control unit 24 identifies the functions of the configuration specified by the user. For example, computer-aided design (CAD) software (e.g., drawing software), video editing software, audio playback software, and the like are installed in the laptop PC (A), and the laptop PC (A) has functions to be implemented by the pieces of software.

Subsequently, by referring to the collaborative function management table, the identification unit 26 identifies configurations (the device 12, software, targets) that are usable for executing a collaborative function in collaboration with a function included in the list 84. In an exemplary case, a function (collaborative function) of transferring data by email by using the CAD software and email software, the data having been created by using the CAD software, is registered in the collaborative function management table. In this case, the identification unit 26 identifies the CAD software and the email software as collaboration candidates. Note that the email software may be installed in the laptop PC (A) or may be installed in the terminal apparatus 10.

In a case where the CAD software and the email software are identified as the collaboration candidates in the above manner, the control unit 24 controls providing a guide from the CAD software to the email software. For example, the control unit 24 causes an image 86 to be displayed on the screen 40. The image 86 represents an arrow extending from a character string indicating the CAD software in the list 84 to the image 56 associated with the email software. That is, the control unit 24 causes the image 86 of the arrow to be displayed on the screen 40, the arrow connecting the character string indicating the CAD software and the image 56 to each other. This makes it possible to present the collaboration candidates to the user by using the list of functions and the image associated with the configuration. In addition, the control unit 24 causes a display frame 88 to be displayed on the screen 40 in association with the character string indicating the CAD software. The control unit 24 also causes information to be displayed within the display frame 88, the information indicating details of the collaborative function that is executable by using the CAD software and the email software.

For example, if the user specifies the display frame 88 by operating the UI unit 20, the control unit 24 sets the collaborative function for the laptop PC (A) and transmits control information indicating the collaborative function to the laptop PC (A). In accordance with the control information, the laptop PC (A) transfers data created by using the CAD software installed in the laptop PC (A) to a destination by email created by using the email software installed in the laptop PC (A).

In a case where the email software installed in the terminal apparatus 10 is used for the collaborative function, the control unit 24 sets the collaborative function for the laptop PC (A) and the terminal apparatus 10. The laptop PC (A) transmits data created by using the CAD software to the terminal apparatus 10. The control unit 24 of the terminal apparatus 10 transfers the data to a destination by email created by using the email software installed in the terminal apparatus 10.

In a case where a plurality of combinations of configurations that are usable for executing a collaborative function are present, the control unit 24 may control guides to the plurality of combinations. This process will be described with reference to FIG. 10. FIG. 10 illustrates an example of the screen 40. In an exemplary case, a transfer function (collaborative function) and a playback function (collaborative function) are registered in the collaborative function management table. The transfer function is a function of transferring data by email by using the CAD software and the email software included in the list 84, the data having been created by using the CAD software. The playback function is a function of playing back music data by using music playback software and the audio device E included in the list 84. In this case, the identification unit 26 identifies a combination (first combination) of the CAD software and the email software and a combination (second combination) of the music playback software and the audio device E as collaboration candidates. This makes it possible to present the plurality of combinations of collaboration candidates to the user by using the list of functions and the images associated with the configurations.

In a case where the first combination and the second combination are identified as in the above case, the control unit 24 controls a guide from the CAD software to the email software as a guide to the first combination, and controls a guide from the music playback software to the audio device E as a guide to the second combination. For example, the control unit 24 causes the image 86 of the arrow to be displayed on the screen 40, the arrow extending from the character string indicating the CAD software in the list 84 to the image 56 associated with the email software. In addition, the control unit 24 causes an image 90 to be displayed on the screen 40. The image 90 represents an arrow extending from a character string indicating the music playback software in the list 84 to the image 50 associated with the audio device E. Furthermore, the control unit 24 causes the display frame 88 and a display frame 92 to be displayed on the screen 40. The display frame 88 is associated with the character string indicating the CAD software, and the display frame 92 is associated with the character string indicating the music playback software. The control unit 24 also causes information to be displayed within the display frame 88, the information indicating details of the collaborative function that is executable by using the CAD software and the email software, and causes information to be displayed within the display frame 92, the information indicating details of the collaborative function that is executable by using the music playback software and the audio device E. As in the second example, the collaborative functions are set for the configurations by a user operation and executed.

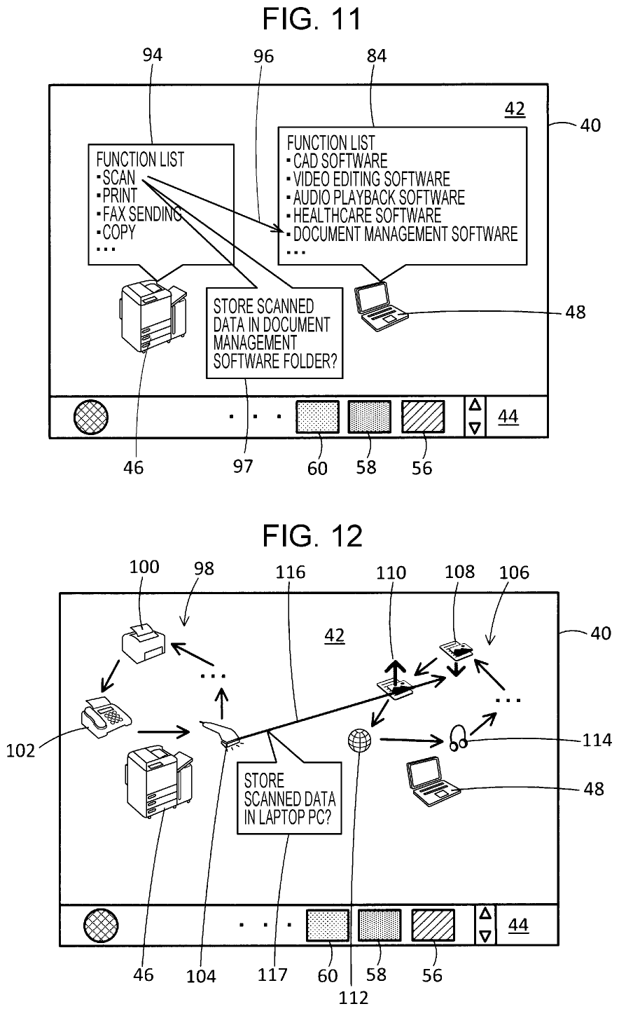

Alternatively, a plurality of lists may be displayed on the screen 40, and guides may be displayed between the lists. This process will be described with reference to FIG. 11. FIG. 11 illustrates an example of the screen 40. For example, if a user specifies the image 46 associated with the multi-function peripheral, the control unit 24 causes a list 94 of functions of the multi-function peripheral to be displayed on the screen 40 in association with the image 46. By referring to the collaborative function management table, the identification unit 26 identifies another configuration that is usable for executing a collaborative function in collaboration with the multi-function peripheral. For example, in a case where the other configuration is the laptop PC (A), the control unit 24 causes the list 84 of functions of the laptop PC (A) to be displayed on the screen 40 in association with the image 48. The functions of the multi-function peripheral and the functions of the laptop PC (A) are, for example, registered in advance in the collaborative function management table. Note that the list 94 corresponds to an example of a first list, and the list 84 corresponds to an example of a second list.

In addition, the identification unit 26 identifies a function that is included in the list 84 and that is usable for executing a collaborative function in collaboration with a function included in the list 94. In an exemplary case, a storage function (collaborative function) is registered in the collaborative function management table. The storage function is a function of storing data that is scanned by using the multi-function peripheral in a folder of document management software by using a scan function included in the list 94 and document management software included in the list 84. In this case, the identification unit 26 identifies a combination of the scan function and the document management software as collaboration candidates.

In a case where the combination is identified in the above manner, the control unit 24 controls a guide from the scan function to the document management software as a guide to the combination. For example, the control unit 24 causes an image 96 to be displayed on the screen 40. The image 96 represents an arrow extending from a character string indicating the scan function in the list 94 to a character string indicating the document management software in the list 84. This makes it possible to present the collaboration candidates to the user by using the plurality of lists. In addition, the control unit 24 causes a display frame 97 to be displayed on the screen 40 in association with the character string indicating the scan function. The control unit 24 also causes information to be displayed within the display frame 97, the information indicating details of the collaborative function that is executable by using the scan function and the document management software. As in the second example, the collaborative function is set for the configurations by a user operation and executed.

Although the lists of functions of the devices 12 are displayed in the above example, in a case where software corresponds to a collaboration candidate, a list of functions of the software may be displayed, and a guide to a function included in the list may be displayed.

In addition, images associated with the functions of the devices 12 or the software may be displayed on the screen 40. This display example will be described with reference to FIG. 12. FIG. 12 illustrates an example of the screen 40.

As an example, in the main display region 42 of the screen 40, the image 48 associated with the laptop PC (A) and the image 46 associated with the multi-function peripheral are displayed. The control unit 24 causes a function image group 98 to be displayed around the image 46 associated with the multi-function peripheral. The function image group 98 represents a group of functions of the multi-function peripheral. The function image group 98 includes function images 100, 102, 104, and the like. The function image 100 is associated with a print function of the multi-function peripheral. The function image 102 is associated with a facsimile function of the multi-function peripheral. The function image 104 is associated with a scan function of the multi-function peripheral. Likewise, the control unit 24 causes a function image group 106 to be displayed around the image 48 associated with the laptop PC (A). The function image group 106 represents a group of functions of the laptop PC (A). The function image group 106 includes function images 108, 110, 112, and 114, and the like. The function image 108 is associated with a download function of the laptop PC (A). The function image 110 is associated with an upload function of the laptop PC (A). The function image 112 is associated with a web browser function of the laptop PC (A). The function image 114 is associated with a music playback function of the laptop PC (A).

The control unit 24 causes the function images included in the function image group 98 to be displayed on the screen 40 so as to circulate in the direction indicated by arrows at a predetermined speed. In a case where not all of the function images included in the function image group 98 are displayed on the screen 40, function images at early orders are displayed whereas function images at later orders are not displayed. As the function images circulate, the function images at early orders disappear from the screen 40 to transition to the function images at later orders, and the function images at later orders transition to the function images at early orders on the screen 40. The same applies to the function image group 106. This way of display makes it possible to present a larger number of function images to the user on the screen having a limited space.

The control unit 24 may cause the function image group 98 to be displayed on the screen 40 if the user specifies the image 46. Alternatively, the control unit 24 may cause the function image group 98 to be displayed on the screen 40 even if the user does not specify the image 46. The same applies to the function image group 106.

In a case where the user specifies the image 46, if the laptop PC (A) is registered in the collaborative function management table as a configuration that is usable for executing a collaborative function in collaboration with the multi-function peripheral, which is associated with the image 46, the control unit 24 may cause the function image group 106 regarding the laptop PC (A) to be displayed on the screen 40.

For example, if the user specifies the function image 104 associated with the scan function of the multi-function peripheral, by referring to the collaborative function management table, the identification unit 26 identifies configurations (the devices 12, software, targets) that are usable for executing a collaborative function in collaboration with the scan function, and further identifies a function (a function of a device 12 or software) that is executable in collaboration with the scan function. For example, in a case where the download function of the laptop PC (A) is registered in the collaborative function management table as a function that is usable for executing a collaborative function in collaboration with the scan function, the identification unit 26 identifies the download function as a collaboration candidate.

In a case where the collaboration candidate is identified in the above manner, the control unit 24 provides a guide to the collaboration candidate. For example, the control unit 24 causes an image 116 to be displayed on the screen 40. The image 116 represents an arrow extending from the function image 104 associated with the scan function to the function image 108 associated with the download function. In addition, the control unit 24 causes a display frame 117 to be displayed on the screen 40, and also causes information to be displayed within the display frame 117, the information indicating details of the collaborative function that is executable by using the scan function and the download function.

The control unit 24 may cause the function image 108 associated with the download function to be displayed on the screen 40 more preferentially than the other function images in place of, or in addition to, display of the image 116 of the arrow. For example, the control unit 24 causes the function image 108 to be displayed on the screen 40 as a function image corresponding to the highest level in the circulation. Specifically, the control unit 24 causes the function image 108 to be displayed at a position closest to the image 46 associated with the multi-function peripheral that is specified by the user in positions of the function images included in the function image group 106. In this case, the control unit 24 may cause the function image 108 to be displayed at the position closest to the image 46 by circulating the function image group 106 or may move the function image 108 to the position closest to the image 46 without circulating the function image group 106. This makes it possible to increase the user's visibility of the images of the collaboration candidates.

Note that in the third example, as in the second example, the identification unit 26 may identify a collaboration candidate on the basis of a use history of the configurations, compatibility between the configurations, or the user's use trend. For example, a guide to a combination of functions whose collaboration frequency is higher than or equal to a threshold may be provided between the first list and the second list by using an image of an arrow or the like. In addition, a guide to a function whose collaboration frequency is higher than or equal to a threshold in the function image group 106 may be displayed. The same applies to the compatibility between the configurations.

### FOURTH EXAMPLE

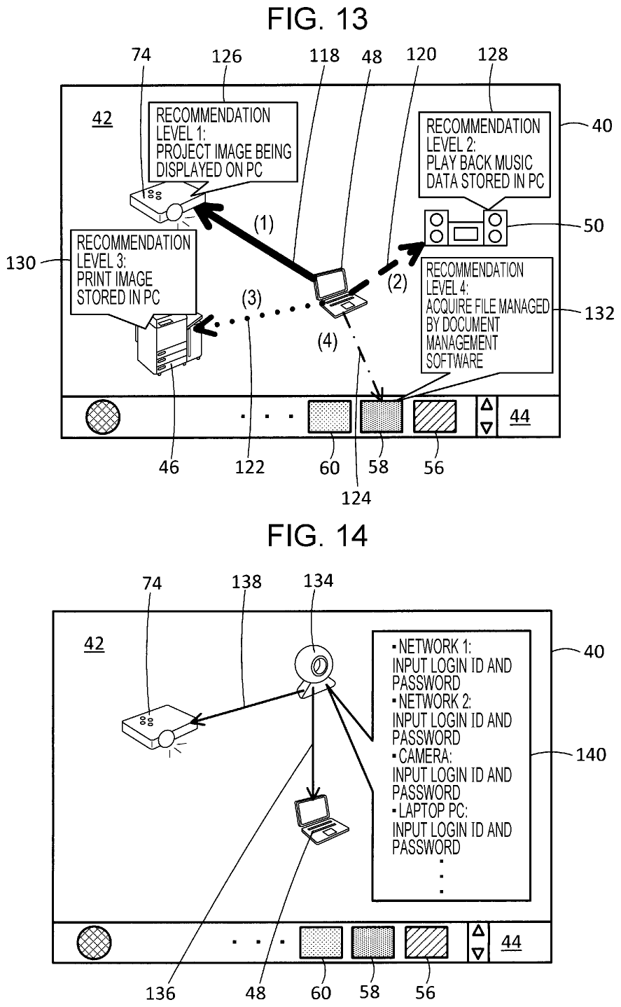

Now, a fourth example will be described with reference to FIG. 13. FIG. 13 illustrates the screen 40. In the fourth example, depending on a priority level of a combination of configurations that are usable for executing a collaborative function, the control unit 24 changes the way of providing a notification of the combination. For example, depending on the priority level of a combination, the control unit 24 changes the way of display of an arrow image that provides a guide to the combination. A specific example will be described below.

As illustrated in FIG. 13, if a user specifies the image 48 associated with the laptop PC (A) by operating the UI unit 20, by referring to the collaborative function management table, the identification unit 26 identifies configurations (the devices 12, software, targets) that are usable for executing a collaborative function in collaboration with the laptop PC (A). In this exemplary case, the projector D, the audio device E, the multi-function peripheral, and the document management software are registered in the collaborative function management table as configurations that are usable for executing a collaborative function in collaboration with the laptop PC (A). In this case, the identification unit 26 identifies, as collaboration candidates, a combination (first combination) of the laptop PC (A) and the projector D, a combination (second combination) of the laptop PC (A) and the audio device E, a combination (third combination) of the laptop PC (A) and the multi-function peripheral, and a combination (fourth combination) of the laptop PC (A) and the document management software.

In the collaborative function management table, priority levels of collaborative functions are determined in advance. The priority levels are determined on the basis of, for example, a history of collaboration of the configurations, a collaboration frequency, a frequency of using the configurations, compatibility between the configurations, and the like. The priority levels of the collaborative functions may be updated in accordance with the use of collaborative functions.

In this exemplary case, the above first to fourth combinations have the following priority levels: a collaborative function that is executable by using the first combination has the highest priority level; a collaborative function that is executable by using the second combination has the second highest priority level; a collaborative function that is executable by using the third combination has the third highest priority level; and a collaborative function that is executable by using the fourth combination has the fourth highest priority level.

The control unit 24 indicates the priority levels of the combinations by using character strings, numerals, or types of arrows. In the example illustrated in FIG. 13, the control unit 24 causes an image 118, an image 120, an image 122, and an image 124 to be displayed on the screen 40. The image 118 represents an arrow connecting the image 48 and the image 74 that belong to the first combination to each other. The image 120 represents an arrow connecting the image 48 and the image 50 that belong to the second combination to each other. The image 122 represents an arrow connecting the image 48 and the image 46 that belong to the third combination to each other. The image 124 represents an arrow connecting the image 48 and the image 58 that belong to the third combination to each other.

The control unit 24 may change thicknesses of the arrows, colors of the arrows, or types of the arrows in accordance with the priority levels. For example, as the priority level of a combination is higher, the combination is indicated by an image of a thicker arrow. For example, the image 118 represents the thickest arrow, and an image of a thinner arrow is displayed for a lower level as an image that provides a guide to a combination. This makes it possible to present the priority levels to the user with high visibility. Alternatively, the control unit 24 may cause numerals representing the priority levels to be displayed on the screen 40.

In addition, the control unit 24 causes a display frame 126, a display frame 128, a display frame 130, and a display frame 132 to be displayed on the screen 40. The display frame 126 is associated with the image 74 that belongs to the first combination. The display frame 128 is associated with the image 50 that belongs to the second combination. The display frame 130 is associated with the image 46 that belongs to the third combination. The display frame 132 is associated with the image 58 that belongs to the fourth combination. The control unit 24 also causes the following details to be displayed within the display frames 126, 128, 130, and 132, respectively: details of the collaborative function related to the first combination, details of the collaborative function related to the second combination, details of the collaborative function related to the third combination, and details of the collaborative function related to the fourth combination.

### FIFTH EXAMPLE

Now, a fifth example will be described with reference to FIG. 14. FIG. 14 illustrates the screen 40. In the fifth example, the control unit 24 controls providing a notification of authentication confirmation for using a configuration included in a combination of configurations that are usable for executing a collaborative function. For example, the control unit 24 causes the display unit of the UI unit 20 to display an input box for inputting information for the authentication. If the authentication of authentication information input to the input box is successful, a configuration as an authentication target becomes usable. A communication path such as a network to be used for executing the collaborative function may also be authenticated. A specific example will be described below.

As illustrated in FIG. 14, if a user specifies an image 134 associated with a camera by operating the UI unit 20, by referring to the collaborative function management table, the identification unit 26 identifies a configuration that is usable for executing a collaborative function in collaboration with the camera. In an exemplary case, the laptop PC (A) and the projector D are registered in the collaborative function management table as configurations that are usable for executing a collaborative function in collaboration with the camera. In this case, the identification unit 26 identifies the laptop PC (A) and the projector D as collaboration candidates. As in the above examples, the control unit 24 causes an image 136 and an image 138 to be displayed on the screen 40. The image 136 represents an arrow that provides a guide to the laptop PC (A), and the image 138 represents an arrow that provides a guide to the projector D.

In addition, the control unit 24 causes an input box 140 for inputting authentication information to be displayed on the screen 40. The authentication information is information for logging in to configurations and communication paths used for the collaborative function, such as login IDs and passwords. The input box 140 includes, for example, input boxes for inputting authentication information for logging in to networks 1 and 2, the camera specified by the user, the laptop PC (A), and the projector D. The networks 1 and 2, the camera, the laptop PC (A), and the projector D are to be used for the collaborative function. For example, in a case where the user inputs the login ID and the password for logging in to the camera to the input box 140, the terminal apparatus 10 transmits the login ID and the password to the camera or an authentication server. If an authentication process performed by the camera or the authentication server is successful, the user is allowed to use the camera. The same applies to the other configurations and networks. In a case where software is used for the collaborative function, an authentication process for using the software may be performed.

The user can log in to each configuration by inputting authentication information of the configuration to the input box 140. The same applies to networks. By inputting authentication information of a plurality of configurations into the input box 140 at once, authentication processes for the plurality of configurations are performed at once.

Among a plurality of configurations to be used for the collaborative function, the control unit 24 may distinguish a plurality of configurations with the same authentication information from the other configurations for display, or may distinguish a plurality of configurations with different authentication information from the other configurations for display. In a case of using a plurality of configurations with different authentication information, the level of security of each configuration may be increased compared with a case of using a plurality of configurations with the same authentication information.

The control unit 24 may cause an input box to be displayed on the screen 40, the input box being used for inputting authentication information of a configuration that is specified by the user. For example, if the user specifies the image 134, the control unit 24 causes an input box for inputting authentication information of the camera to be displayed on the screen 40. In addition, the control unit 24 may cause input boxes to be displayed on the screen 40, the input boxes being used for individually inputting authentication information of the laptop PC (A) and authentication information of the projector D, the laptop PC (A) and the projector D each being a configuration usable for executing a collaborative function in collaboration with the camera. That is, the control unit 24 may cause input boxes to be separately displayed on the screen 40, the input boxes including an input box for inputting the authentication information of the camera, an input box for inputting the authentication information of the laptop PC (A), and an input box for inputting the authentication information of the projector D. The same applies to the networks 1 and 2.

The plurality of configurations to be used for a collaborative function may include both a configuration for which authentication is necessary and a configuration for which authentication is unnecessary. In this case, the control unit 24 may cause information indicating the configuration for which authentication is necessary to be displayed on the screen 40. This makes it possible to present a higher-security configuration to the user compared with a case where a configuration for which authentication is unnecessary is presented to the user. For example, in a case where the camera corresponds to a device 12 for which authentication is necessary, the control unit 24 causes information indicating this to be displayed on the screen 40.

In addition, the control unit 24 may cause a configuration for which authentication is necessary to be displayed more preferentially than a configuration for which authentication is unnecessary. This makes it possible to preferentially present a higher-security configuration to the user. For example, in a case where the laptop PC (A) corresponds to a device 12 for which authentication is necessary and the projector D corresponds to a device 12 for which authentication is unnecessary, the control unit 24 causes the image 48 associated with the laptop PC (A) to be displayed more preferentially on the screen 40 than the image 74 associated with the projector D. The control unit 24 may cause an image of a thicker arrow than the arrow of the image 138 to be displayed as the image 136 on the screen 40 or may cause the image 48 to be displayed to be larger than the image 74 on the screen 40. Obviously, the control unit 24 may cause a configuration for which authentication is unnecessary to be displayed more preferentially than a configuration for which authentication is necessary. This makes it possible to preferentially present to the user, a configuration for which authentication can be omitted.

In addition, among configurations to be used for a collaborative function, the control unit 24 may cause a guide to a configuration for which authentication is necessary to be displayed on the screen 40, and may hide from display, a guide to a configuration for which authentication is unnecessary. In an exemplary case, the laptop PC (A) corresponds to a device 12 for which authentication is necessary, and the projector D corresponds to a device 12 for which authentication is unnecessary. In this case, the control unit 24 causes the image 136 to be displayed on the screen 40 and does not cause the image 138 to be displayed on the screen 40, the image 136 providing a guide to the laptop PC (A) and the image 138 providing a guide to the projector D. Thus, a higher-security configuration is presented to the user.

Furthermore, for configurations to be used for a collaborative function, the control unit 24 may cause a guide to a configuration for which authentication has been performed to be displayed on the screen 40, and may hide from display, a guide to a configuration for which authentication is yet to be performed. This makes it possible to present a higher-security configuration to the user and also to reduce the user's labor for authentication. In this exemplary case, the laptop PC (A) corresponds to a device 12 for which authentication has been performed, and the projector D corresponds to a device 12 for which authentication is yet to be performed. In this case, the control unit 24 causes the image 136 to be displayed on the screen 40 and does not cause the image 138 to be displayed on the screen 40, the image 136 providing a guide to the laptop PC (A) and the image 138 providing a guide to the projector D.

### SIXTH EXAMPLE

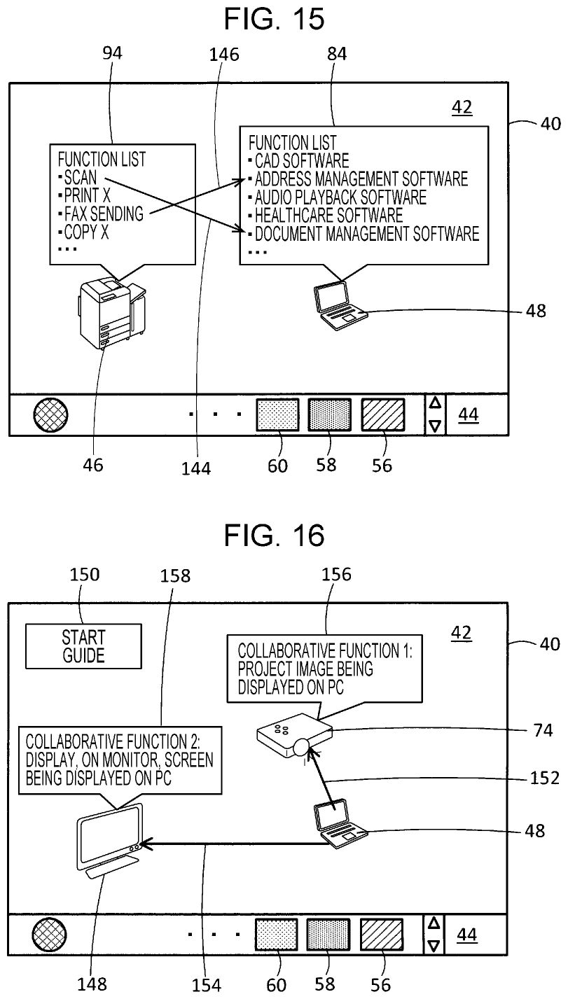

Now, a sixth example will be described with reference to FIG. 15. FIG. 15 illustrates the screen 40. In the sixth example, in accordance with a status of a configuration, the control unit 24 changes a combination of configurations as targets to be guided for a collaborative function. Examples of the status of a configuration include a working status (e.g., during use, under suspension, or the like) of a device 12, a remaining amount of a consumable of the device 12, a working status (e.g., during use, under suspension, or the like) of software, a position of the device 12, an environment in which the device 12 is installed, and the like. A specific example will be described below.

In the example illustrated in FIG. 15, a user specifies the image 46 associated with the multi-function peripheral, and the list 94 of functions of the multi-function peripheral is displayed on the screen 40 in association with the image 46. In addition, the laptop PC (A) is identified as a device 12 that is usable for executing a collaborative function in collaboration with the multi-function peripheral, and the list 84 of functions of the laptop PC (A) is displayed on the screen 40 in association with the image 48.

The control unit 24 collects, from each configuration, information indicating the status of the configuration, and provides a guide in accordance with the status of the configuration. For example, in a case where the multi-function peripheral runs out of ink, a print function and a copy function, which are assumed to use ink, correspond to functions that are not executable by using the multi-function peripheral. Accordingly, even if the laptop PC (A) has a function that is usable for executing a collaborative function in collaboration with the print function, the control unit 24 does not provide a guide to a combination of the print function and this function. The same applies to the copy function. Note that the control unit 24 may cause information (e.g., an X mark) to be displayed around a character string indicating the print function, the information indicating that it is not possible to use the print function. The same applies to the copy function.

A scan function and a facsimile sending function, which are not assumed to use ink, are actually executable by using the multi-function peripheral. In a case where a collaborative function is executable by causing document management software installed in the laptop PC (A) and the scan function to work in collaboration with each other, the control unit 24 causes an image 144 to be displayed on the screen 40. The image 144 represents an arrow connecting a character string indicating the scan function and a character string indicating the document management software to each other. Likewise, in a case where a collaborative function is executable by causing address management software installed in the laptop PC (A) and the facsimile sending function to work in collaboration with each other, the control unit 24 causes an image 146 to be displayed on the screen 40. The image 146 represents an arrow connecting a character string indicating the facsimile sending function and a character string indicating the address management software to each other.

In addition, in a case where a device 12 or a function of the device 12 is currently during use or is to be used for a predetermined period of time or longer from the present time point, the control unit 24 does not have to provide a guide to a combination including the device 12 or the function. The same applies to software.

Through the above process, actually usable configurations are presented to the user as collaboration candidates.

In a case where the status of the configuration is ever-changing, in accordance with the change, the guide is also changed. That is, even if a guide to a combination of configurations is currently provided, the guide may not be provided in the future. Conversely, even if a guide to a combination of configurations is not currently provided owing to the status of the configuration, the guide may be provided in the future. Thus, even in a case where the status of the configuration changes, a guide in accordance with the status can be provided to the user.

### SEVENTH EXAMPLE

Now, a seventh example will be described with reference to FIG. 16. FIG. 16 illustrates the screen 40. In the first to sixth examples described above, if a user specifies an image associated with a device 12 or software, a guide to a combination of configurations that are usable for executing a collaborative function is provided. In the seventh example, even if the user does not specify an image, a guide to a combination of configurations is provided. A specific example will be described below.

As illustrated in FIG. 15, in the main display region 42 of the screen 40, the image 48 associated with the laptop PC (A), the image 74 associated with the projector D, and an image 148 associated with a TV monitor F are displayed. In this state, by referring to the collaborative function management table, the identification unit 26 identifies a combination of configurations that are usable for executing a collaborative function from among the configurations including the laptop PC (A), the projector D, and the TV monitor F. In an exemplary case, a collaborative function is executable by using a combination (first combination) of the laptop PC (A) and the projector D, and a collaborative function is executable by using a combination (second combination) of the laptop PC (A) and the TV monitor F. In this case, the control unit 24 causes an image 152 and an image 154 to be displayed on the screen 40. The image 152 represents an arrow connecting the image 48, which is associated with the laptop PC (A), and the image 74, which is associated with the projector D, to each other. The image 154 represents an arrow connecting the image 48, which is associated with the laptop PC (A), and the image 148, which is associated with the TV monitor F, to each other. In addition, the control unit 24 causes a display frame 156 and a display frame 158 to be displayed on the screen 40. Details of the collaborative function that is executable by using the first combination are described within the display frame 156, and details of the collaborative function that is executable by using the second combination are described within the display frame 158.

Furthermore, the control unit 24 may cause a guide start button image 150 to be displayed on the screen 40. The control unit 24 does not have to cause the images 152 and 154 of the arrows that provide guides to be displayed on the screen 40 as long as the user does not press the guide start button image 150. The control unit 24 may cause the images 152 and 154 to be displayed on the screen 40 upon the user pressing the guide start button image 150. Obviously, the user may give an instruction for starting a guide by audio.

As in the sixth example, the control unit 24 may change a combination of guide targets in accordance with the status of each configuration. For example, in a status where the TV monitor F is during use and it is not possible to execute a collaborative function in collaboration with the laptop PC (A), the control unit 24 does not cause the image 154 to be displayed on the screen 40, the image 154 providing a guide to the TV monitor F.

The control unit 24 may change the combination of guide targets by using a position of a configuration as the status of the configuration. For example, in a case where a distance between the laptop PC (A) and the TV monitor F in a real space is greater than or equal to a threshold, the control unit 24 does not have to cause the image 154 to be displayed on the screen 40, the image 154 providing a guide to the TV monitor F. In a case where the distance is less than the threshold, the control unit causes the image 154 to be displayed on the screen 40. This makes it possible to present to the user, a plurality of configurations for which the distance therebetween is less than the threshold. The same applies to a case where software is used as a configuration. In this case, the presence or absence of a guide is determined in consideration of an install location of an apparatus in which the software is installed.

The control unit 24 may change a combination of guide targets in accordance with a status of the user. Examples of the status of the user include a time slot during which the user operates a device 12, software, or the terminal apparatus 10, a schedule of the user, a position of the user, a working status of the user, a positional relationship between the user and a configuration, and the like.

For example, previous time slots during which the devices 12, the software, and the terminal apparatus 10 were operated are managed as a history, and history information thereof is stored in the terminal apparatus 10, the devices 12, or an apparatus such as a server. In addition, for each collaborative function, a time slot during which the collaborative function was executed may be managed as a history, and the history information may include information indicating the time slot during which the collaborative function was executed. By referring to the history information, the control unit 24 estimates a time slot during which the user operates the devices 12, the software, and the terminal apparatus 10. The control unit 24 may also estimate a time slot during which the user uses the collaborative function. On the basis of the estimation results, the control unit 24 provides a guide to a combination of configurations that may be used for the collaborative function. For example, during a time slot during which a collaborative function using the laptop PC (A) and the projector D may be used (e.g., a time slot during which the collaborative function was executed in the past), the control unit 24 provides a guide to a combination of the laptop PC (A) and the projector D required for the collaborative function. Specifically, the control unit 24 causes the image 152 of the arrow to be displayed on the screen 40 during this time slot, and does not cause the image 152 to be displayed on the screen 40 during time slots other than the above time slot. This makes it possible to provide to the user, a guide to a combination of configurations to be used for a collaborative function during a time slot during which the collaborative function is necessary for the user. In addition, a use frequency of the collaborative function may be used. For example, the control unit 24 calculates the use frequency in units of time slots for each collaborative function, and identifies a unit time slot during which the use frequency is higher than or equal to a threshold for each collaborative function. The control unit 24 then provides a guide to a combination of configurations to be used for a collaborative function whose use frequency is higher than or equal to the threshold for each unit time slot. For example, in a case where the use frequency of the collaborative function using the laptop PC (A) and the projector D is higher than or equal to the threshold during a certain time slot, the control unit 24 causes the image 152 of the arrow to be displayed on the screen 40 during the time slot, but does not cause the image 152 to be displayed on the screen 40 during time slots other than the above time slot. This makes it possible to provide to the user, a guide to a combination of configurations to be used for a collaborative function during a time slot during which the user is predicted to use the collaborative function.

In addition, the control unit 24 may use the schedule of the user. For example, information indicating the schedule of each user is managed by the terminal apparatus 10 or an external apparatus such as a server, and the control unit 24 acquires information on the schedule of a user who has logged in to the terminal apparatus 10. On the basis of the schedule of the user, the control unit 24 predicts a combination of configurations that are required for a collaborative function that may be used by the user, and causes an image to be displayed on the screen 40. The image represents an arrow that provides a guide to the combination of configurations. For example, in a case where the user is supposed to go out, the control unit 24 identifies a collaborative function that is assumed to be used where the user has gone, and provides a guide to a combination of configurations that are required for the collaborative function. On the basis of the previous use history of a collaborative function, the control unit 24 may identify a collaborative function that corresponds to the schedule of the user, and may provide a guide to a combination of configurations that are required for the collaborative function. For example, in a case where the user is supposed to go out, the control unit 24 identifies a collaborative function that was used when the user was out or a collaborative function whose use frequency when the user is out is higher than or equal to a threshold, and provides a combination of configurations that are required for the collaborative function. In addition, in a case where the user is supposed to attend a meeting, the control unit 24 may identify a collaborative function that has been used in a meeting or a collaborative function whose use frequency in a meeting is higher than or equal to a threshold, and may provide guides to configurations required for the collaborative function. This makes it possible to provide to the user, guides to configurations required for a collaborative function that is suitable for the schedule of the user.

In addition, the control unit 24 may use a position of a user who uses the terminal apparatus 10. For example, the control unit 24 identifies a position of the terminal apparatus 10 (the user) by using the global positioning system (GPS) or the like. In a case where the user stays indoors, the control unit 24 identifies a collaborative function that may be used indoors and provides a guide to a combination of configurations that are required for the collaborative function. For example, the control unit 24 identifies a collaborative function that is executable by using devices 12 installed indoors and provides guides to the devices 12 as the configurations used for the collaborative function. The same applies to a case where the user stays outdoors. Note that in the collaborative function management table, information indicating whether each collaborative function is suitable for an indoor environment or an outdoor environment is associated with the collaborative function, and the control unit 24 identifies the collaborative function that is suitable for an indoor environment or an outdoor environment by referring to the collaborative function management table. This makes it possible to provide to the user, guides to configurations required for a collaborative function that is suitable for the position of the user.

In addition, the control unit 24 may use a working status of the user who uses the terminal apparatus 10. For example, if the user is creating a document by using presentation software, by referring to the collaborative function management table, the identification unit 26 identifies a configuration (e.g., the projector D) that is usable for executing a collaborative function in collaboration with the presentation software. The document created by using the presentation software may be projected by using a projector. That is, the projector may be used subsequently to the presentation software. Thus, the control unit 24 provides a guide to the projector D as a collaboration candidate. For example, the control unit 24 causes an image to be displayed on the screen 40. The image represents an arrow connecting the image 58, which is associated with the presentation software, and the image 74, which is associated with the projector D, to each other. If the user is creating a document by using document creation software, by referring to the collaborative function management table, the identification unit 26 identifies a configuration (e.g., a multi-function peripheral) that is usable for executing a collaborative function in collaboration with the document creation software. The document created by using the document creation software may be printed by using the multi-function peripheral. That is, the multi-function peripheral may be used subsequently to the document creation software. Thus, the control unit 24 provides a guide to the multi-function peripheral as a collaboration candidate. For example, the control unit 24 causes an image to be displayed on the screen 40. The image represents an arrow connecting an image associated with the document creation software and an image associated with the multi-function peripheral to each other. This makes it possible to present to the user, a configuration to be used for a collaborative function that is suitable for the working status of the user.

In addition, the control unit 24 may use a positional relationship between the user who uses the terminal apparatus 10 and each configuration (the devices 12 or an apparatus in which software is installed). The control unit 24 identifies the position of the terminal apparatus 10 (the user) and the position of each configuration by using the GPS or the like. For example, as a configuration to be used for a collaborative function, the control unit 24 may provide a guide to a device 12 that is positioned close to the user or a device 12 that is installed on the same floor as the user. For example, in a case where a plurality of combinations of configurations that are usable for executing a collaborative function are displayed on the screen 40, from among the plurality of combinations, the control unit 24 may provide a guide (may display an arrow image) to a combination of configurations for which a distance from the user is greater than or equal to a threshold or a combination of configurations for which a distance from the user is the shortest. In the example illustrated in FIG. 16, in a case where the distance between the laptop PC (A) and the user is less than or equal to the threshold and the distance between the projector D and the user is less than or equal to the threshold, the control unit 24 causes the image 152 of the arrow that provides a guide to be displayed on the screen 40. On the other hand, in a case where the distance between the TV monitor F and the user exceeds the threshold, the control unit 24 does not cause the image 154 of the arrow that provides a guide to be displayed on the screen 40. This makes it possible to provide to the user, a guide to a configuration that is to be used for a collaborative function and that is close to the user.

In addition, in accordance with an editing status of data stored in the storage unit 22 of the terminal apparatus 10, the control unit 24 may change a combination of configurations that are used for executing a collaborative function by using the data and may provide a guide to the combination after change. For example, for each type of data, a collaborative function in accordance with the data editing status and a combination of configurations to be used for the collaborative function are registered in association with each other in the collaborative function management table. Examples of the types of data registered include a document file, an image file (still image file, moving image file), a figure file, a music file, a presentation file, and the like. Examples of the data editing status include during editing, editing completed and stored, and the like. The identification unit 26 detects the data editing status. By referring to the collaborative function management table, the identification unit 26 identifies a collaborative function (a collaborative function in association with the data editing status) that is assumed to be used in the detected editing status and identifies a combination of configurations to be used for the collaborative function (a combination of configurations in association with the collaborative function) as collaboration candidates. The control unit 24 causes an image to be displayed on the screen 40. The image represents an arrow that provides a guide to the combination of configurations identified in the above manner. This makes it possible to provide to the user, configurations to be used for a collaborative function that is suitable for the data editing status.

For example, in a case where the user is editing a document file, the identification unit 26 identifies a collaborative function in association with the editing status where the document file is being edited, and identifies a combination of configurations to be used for the collaborative function. In addition, in a case where editing of the document file is completed and the edited document file is stored in the storage unit 22, the identification unit 26 identifies a collaborative function in association with the editing status where editing is completed, and identifies a combination of configurations to be used for the collaborative function. The control unit 24 provides a guide to the combination of configurations identified in the above manner. While the document file is being edited, a guide is provided to a combination of configurations that are required for a collaborative function in accordance with the editing status where the document file is being edited; once editing of the document file is completed and the edited document file is stored, a guide is provided to a combination of configurations that are required for a collaborative function in accordance with the editing status where editing is completed.

In a case where a change amount of data becomes greater than or equal to a threshold by editing, the control unit 24 may change the combination of configurations as a guide target.

In each of the above-described examples, prior to execution of a collaborative function, the control unit 24 may provide a guide (e.g., displays an arrow image) to a combination of configurations to be used for the collaborative function.

Alternatively, while the collaborative function is being executed by using the combination of configurations, the control unit 24 may provide a guide to a combination of configurations that are required for executing another collaborative function. For example, while a collaborative function 1 in which “an image that is being displayed on the laptop PC (A) is projected by using the projector D” illustrated in FIG. 16 is being executed by using the laptop PC (A) and the projector D, the control unit 24 causes the image 154 to be displayed on the screen 40, the image 154 providing a guide to a combination of the laptop PC (A) and the TV monitor F. It is needless to say that the control unit 24 may also cause the image 152 to be displayed on the screen 40. This makes it possible to present to the user, another collaborative function and a combination of configurations that are required for the other collaborative function while a certain collaborative function is being executed.

In addition, in each of the above-described examples, if an image associated with a configuration is additionally displayed on the screen 40, if an image associated with a configuration is removed from the screen 40, or if new software is installed in the terminal apparatus 10, for example, the control unit 24 updates a guide to a combination of configurations that are required for a collaborative function. For example, if an image associated with a configuration is additionally displayed on the screen 40, the identification unit 26 identifies another configuration that is usable for executing a collaborative function in collaboration with the configuration, and the control unit 24 causes an image to be displayed on the screen 40, the image representing an arrow that provides a guide to the collaborative function. This makes it possible to provide to the user, the guide to the collaborative function in accordance with an operation for adding an image to the screen 40. The same applies to a case where new software is installed in the terminal apparatus 10 and an image associated with the software is displayed on the screen 40. In addition, if an image associated with a configuration is removed from the screen 40 (if the image is hidden from display), the control unit 24 hides from display, a guide to a collaborative function regarding the configuration.

Note that in each of the above-described examples, if it is not possible to execute a collaborative function by using the configurations displayed on the screen 40, that is, if no combination of configurations that are usable for executing a certain collaborative function is displayed on the screen 40, the control unit 24 causes information to be displayed on the screen 40, the information being a message or the like indicating that no combination of configurations that are usable for executing a collaborative function is displayed on the screen 40. Obviously, the control unit 24 may output audio information for this from a speaker.

In addition, in each of the above-described examples, if a function (e.g., a print function assigned to a main part of a multi-function peripheral) assigned to a part of a device 12 (e.g., the main part of the multi-function peripheral) is used for a collaborative function, information (e.g., an arrow image) that provides a guide to the part may be displayed on the screen 40. For example, an arrow image pointing at a part representing the main part in the image associated with the multi-function peripheral is displayed on the screen 40. Also, if software has a plurality of functions and functions are assigned to parts of an image associated with the software, as in the case of the device 12, arrow images pointing at the parts of the image may be displayed.

The above terminal apparatus 10 and devices 12 are achieved by cooperation of hardware and software, for example. Specifically, the terminal apparatus 10 and each of the devices 12 have one or more processors (not shown) such as a CPU. By the one or more processors reading and executing a program stored in a storage apparatus (not shown), functions of units of the terminal apparatus 10 and each of the devices 12 are implemented. The program is stored in the storage apparatus via a recording medium such as a compact disc (CD) or digital versatile disc (DVD) or via a communication path such as a network. As another example, the units of the terminal apparatus 10 and each of the devices 12 may be implemented by hardware resources such as a processor, an electronic circuit, and an application specific integrated circuit (ASIC). A device such as a memory may be used for the implementation. As still another example, the units of the terminal apparatus 10 and each of the devices 12 may be implemented by a digital signal processor (DSP), a field programmable gate array (FPGA), or the like.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a control unit that, if a plurality of configurations are present as collaboration candidates and a plurality of combinations of configurations that are required for executing a collaborative function are present, controls providing a notification of at least one combination among the plurality of combinations.

2. The information processing apparatus according to claim 1, wherein the control unit changes the at least one combination, which is a notification target, in accordance with a status of a configuration.

3. The information processing apparatus according to claim 2, wherein the control unit changes the at least one combination, which is a notification target, by using as the status, a position of the configuration.

4. The information processing apparatus according to claim 1, wherein the control unit changes the at least one combination, which is a notification target, in accordance with a status of a user.

5. The information processing apparatus according to claim 4, wherein the control unit changes the at least one combination, which is a notification target, by using as the status, a time slot during which the user performs an operation.

6. The information processing apparatus according to claim 4, wherein the control unit changes the at least one combination, which is a notification target, by using as the status, a schedule of the user.

7. The information processing apparatus according to claim 4, wherein the control unit changes the at least one combination, which is a notification target, by using as the status, a position of the user.

8. The information processing apparatus according to claim 4, wherein the control unit changes the at least one combination, which is a notification target, by using as the status, a working status of the user.

9. The information processing apparatus according to claim 1, wherein the control unit changes the at least one combination, which is a notification target, in accordance with a positional relationship between a configuration and a user.

10. The information processing apparatus according to claim 1, further comprising
a storage unit that stores data,
wherein, in accordance with an editing status of the data, the control unit changes the at least one combination that is used for executing a collaborative function by using the data.

11. The information processing apparatus according to claim 1, wherein, prior to execution of a collaborative function, the control unit provides a notification of a combination of configurations to be used for the collaborative function, as the at least one combination.

12. The information processing apparatus according to claim 1, wherein, while a collaborative function is being executed by using a combination of configurations, the control unit further controls providing a notification of a combination of configurations that are required for executing another collaborative function.

13. The information processing apparatus according to claim 1, wherein, if a configuration included in the at least one combination, which is a notification target, is specified by a user, the control unit further hides from display, a guide to the configuration specified by the user.

14. The information processing apparatus according to claim 1, wherein, if a configuration is specified by a user, the control unit further controls providing a notification of a first list of functions of the configuration specified by the user and controls providing a notification of the at least one combination in units of functions included in the first list.

15. The information processing apparatus according to claim 14, wherein the control unit further controls providing a notification of one or more configurations that are usable for executing a collaborative function in collaboration with a function included in the first list.

16. The information processing apparatus according to claim 15, wherein the control unit further controls providing a notification of a second list of functions of another configuration that is usable for executing a collaborative function in collaboration with the configuration specified by the user, and controls providing a notification of a function that is included in the second list and that is usable for executing a collaborative function in collaboration with the function included in the first list.

17. The information processing apparatus according to claim 16, wherein the control unit controls display of images associated with the functions included in the first list and images associated with the functions included in the second list, and, if an image associated with a function included in the first list is specified by the user, the control unit causes an image to be displayed more preferentially, the image being associated with a function that is usable for executing a collaborative function in collaboration with the function associated with the image specified by the user and being associated with a function included in the second list, than another image associated with another function included in the second list.

18. The information processing apparatus according to claim 1, wherein the control unit further controls providing a notification of authentication confirmation for using a configuration included in the at least one combination, which is a notification target.

19. The information processing apparatus according to claim 18, wherein the control unit controls providing a notification of authentication confirmation for each configuration.

20. The information processing apparatus according to claim 18, wherein, if the configuration included in the at least one combination, which is a notification target, is specified by a user, the control unit controls providing at least a notification of authentication confirmation for using the configuration specified by the user.

21. The information processing apparatus according to claim 18, wherein the control unit further controls providing a notification of authentication confirmation for using a configuration other than a configuration that is included in the at least one combination, which is a notification target, and that is specified by the user.

22. The information processing apparatus according to claim 1, wherein the control unit further controls providing a notification of a configuration that is included in the at least one combination, which is a notification target, and that has been authenticated.

23. The information processing apparatus according to claim 1, wherein the control unit further controls providing a notification of a configuration that is included in the at least one combination, which is a notification target, and that is required to be authenticated.

24. The information processing apparatus according to claim 1, wherein the control unit changes a way of providing a notification of a combination depending on a priority level of the combination, which is a notification target.

25. The information processing apparatus according to claim 1,
wherein the configurations are one or more devices or one or more pieces of software, and
wherein the control unit provides a notification of a combination including a device that is usable for executing software specified by a user, as the at least one combination.

26. The information processing apparatus according to claim 1, wherein the control unit provides a notification of configurations included in the at least one combination, which is a notification target, in accordance with an order of use for a collaborative function.

27. A non-transitory computer readable medium storing a program causing a computer to execute a process for information processing, the process comprising:
controlling, if a plurality of configurations are present as collaboration candidates and a plurality of combinations of configurations that are required for executing a collaborative function are present, providing a notification of at least one combination among the plurality of combinations.
